(19) United States
(12) Patent Application Publication
(10) Pub. No.: US 2011/0194904 A1
(43) Pub. Date: Aug. 11, 2011

(54) Controlled Inlet of Compressor for Pneumatic Conveying System

(75) Inventor: Michael A. Carlson, Overland Park, KS (US)

(73) Assignee: ACCESSIBLE TECHNOLOGIES, INC., Lenexa, KS (US)

(21) Appl. No.: 13/090,982

(22) Filed: Apr. 20, 2011

Related U.S. Application Data
(63) Continuation-in-part of application No. 12/764,042, filed on Apr. 20, 2010.
(60) Provisional application No. 61/220,635, filed on Jun. 26, 2009.

(51) Int. Cl. B65G 53/66; F04B 49/22

(52) U.S. Cl. 406/12; 417/307

(57) ABSTRACT

A compressor airflow controller is operable to control airflow through a centrifugal compressor. The controller drives the centrifugal compressor and determines if a flow irregularity (e.g., an error in gas flow velocity) has occurred. If a flow irregularity is determined, the controller reduces the irregularity by adjusting compressor operation to thereby change the compressed gas flow.

### RELATED APPLICATION

This application is a continuation-in-part of U.S. application Ser. No. 12/764,042, filed Apr. 20, 2010, entitled COMPRESSOR INLET GUIDE VANE CONTROL, which claims the priority benefit of U.S. Provisional Application Ser. No. 61/220,635, filed Jun. 26, 2009, entitled COMPRESSOR DRIVE AND PNEUMATIC CONVEYING COMPRESSOR, all of which are hereby incorporated in their entirety by reference herein.

### BACKGROUND

1. Field

The present invention relates generally to compressor systems, such as those used in pneumatic conveying systems. More specifically, embodiments of the present invention concern a compressor package with a centrifugal compressor and a controller that controls the airflow through the compressor.

2. Discussion of Prior Art

Centrifugal compressors with guide vanes are known in the art. For example, compressor systems have been developed with inlet guide vanes and/or diffuser guide vanes. Furthermore, it is also known for a centrifugal compressor to have adjustable guide vanes so as to permit control over airflow to and/or from the compressor.

Prior art compressor systems suffer from various limitations. For instance, conventional centrifugal compressors are unable to provide compressed airflow at a substantially constant velocity, particularly when the compressor is exposed to widely varying backpressures or other widely varying environmental conditions. This problem is particularly relevant in the application of centrifugal compressors in pneumatic conveying systems. More specifically, centrifugal compressors are generally deficient at overcoming any blockage in the conveying system that develops downstream of the compressor. Furthermore, in the event of such blockage, the compressor is prone to entering a surge condition.

### SUMMARY

The following brief summary is provided to indicate the nature of the subject matter disclosed herein. While certain aspects of the present invention are described below, the summary is not intended to limit the scope of the present invention.

Embodiments of the present invention provide a compressor assembly that does not suffer from the problems and limitations of the prior art compressor systems, such as those set forth above.

A first aspect of the present invention concerns a method of maintaining a desired gas flow in a pneumatic conveying system. The method broadly includes the steps of driving a centrifugal compressor to direct compressed gas flow into the system; determining if a flow irregularity has occurred, with the flow irregularity determined when a sensed gas flow characteristic is found to be different from a desired value of the gas flow characteristic; and upon such an occurrence, reducing the irregularity by adjusting compressor operation to thereby change the compressed gas flow.

A second aspect of the present invention concerns a controller to maintain a desired gas flow in a pneumatic conveying system. The controller broadly includes a processing element configured to drive a centrifugal compressor to direct compressed gas flow into the system; determine if a flow irregularity has occurred, with the flow irregularity determined when a sensed gas flow characteristic is found to be different from a desired value of the gas flow characteristic; and upon such occurrence, reduce the irregularity by adjusting compressor operation to thereby change the compressed gas flow.

A third aspect of the present invention concerns a compressor airflow control assembly operable to control airflow induced by a centrifugal compressor. The control assembly broadly includes an air valve assembly and a controller assembly. The air valve assembly includes a body that presents a valve passage. The air valve assembly further includes an air valve shiftably mounted in the valve passage to control airflow through the passage. The air valve assembly is operable to be mounted relative to the compressor so that the valve passage fluidly communicates with the compressor and shifting of the valve controls the compressor airflow. The controller assembly is operable to sense an airflow pressure and responsively control shifting of the air valve. The controller assembly includes a fluidly driven actuator and a shiftable fluid valve fluidly connected to the actuator to control pressurized fluid flow from a source to the actuator. The actuator is operably coupled to the air valve so that driven movement of the actuator effects shifting of the air valve within the valve passage. The fluid valve is shiftable so as to vary fluid flow to the actuator causing movement thereof and thereby shifting of the air valve. The controller assembly includes an airflow pressure sensor configured to sense the airflow pressure and operably coupled to the fluid valve so that sensing of the airflow pressure is operable to cause shifting of the fluid valve and a corresponding shifting of the air valve.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary front left perspective of a compressor package constructed in accordance with a first embodiment of the present invention, and showing a base, motor, centrifugal compressor, intake system, transmission, hydraulic assembly, inlet guide vane assembly, and guide vane controller of the compressor package, with the controller including a bypass valve in fluid communication with the compressor discharge and operable to vent compressor airflow to ambient;

FIG. 2 is a fragmentary front right perspective of the compressor package shown in FIG. 1;

FIG. 3 is a fragmentary rear perspective of the compressor package shown in FIGS. 1 and 2, with part of the transmission housing being removed to show an internal gear drive of the transmission;

FIG. 4 is a fragmentary front right perspective of the compressor package shown in FIGS. 1-3, showing the compressor, inlet guide vane assembly, and controller;

FIG. 5 is a front right perspective of the compressor, inlet guide vane assembly, and controller similar to FIG. 4, but showing part of the compressor housing and part of the guide vane housing removed to show the guide vanes and transmission that controls positioning of the guide vanes, with the guide vanes in a predetermined preswirl position and the piston in a corresponding central position, and showing part of the controller housing removed to show a sensor assembly, valve, and hydraulic piston of the controller, with the valve being in a closed position;

FIG. 6 is a right rear perspective of the compressor, inlet guide vane assembly, and controller shown in FIG. 5, with the guide vanes in the predetermined preswirl position and the valve in the closed position;

FIG. 7 is an enlarged front right perspective of the compressor, inlet guide vane assembly, and controller similar to FIG. 5;

FIG. 8 is a front elevation of the inlet guide vane assembly and controller shown in FIGS. 1-7, showing the controller cross-sectioned to depict the valve within the controller housing;

FIG. 9 is a perspective of the valve shown in FIGS. 5, 7, and 8, showing slotted and chamfered ends of the cylindrical valve, with upper and lower slots formed along the slotted end, and showing upper and lower bores extending longitudinally from corresponding upper and lower slots to corresponding ends of the valve;

FIG. 10 is a cross section of the valve shown in FIGS. 5, 7, 8, and 9, showing the upper and lower bores extending longitudinally through the valve;

FIG. 11 is a cross section of the inlet guide vane assembly and controller shown in FIGS. 1-8, showing the valve rotated into the closed position, with the closed valve preventing fluid flow between the upper and lower slots and the supply and return bores;

FIG. 12 is a front right perspective of the compressor, inlet guide vane assembly, and controller similar to FIG. 5, but showing the sensor assembly pivoted rearwardly toward the inlet guide vanes in response to a high-velocity intake airflow so that the valve assumes a vane-closing position, with the valve permitting pressurized supply fluid to flow from the supply bore to the right piston chamber so that the piston is shifted into a left endmost position, and with the inlet guide vanes being shifted by the piston into a corresponding maximum preswirl condition to generally reduce the airflow to the compressor;

FIG. 13 is a cross section of the inlet guide vane assembly and controller similar to FIG. 11, but showing the valve pivoted into the vane-closing position, with the upper slot of the valve fluidly communicating with the supply bore and the lower slot of the valve fluidly communicating with the return bore;

FIG. 14 is a front right perspective of the compressor, inlet guide vane assembly, and controller similar to FIG. 5, but showing the sensor assembly pivoted forwardly from the inlet guide vanes in response to a low-velocity intake airflow so that the valve assumes a vane-opening position, with the valve permitting pressurized supply fluid to flow from the supply bore to the left piston chamber so that the piston is shifted into a right endmost position, with the inlet guide vanes being shifted by the piston into a corresponding maximum counterswirl condition to generally increase the airflow velocity and, in instances where the counterswirl condition does not increase the low-velocity airflow to a predetermined velocity, the left piston chamber exceeds a predetermined pressure so that a pressure relief valve allows fluid to flow from the left piston chamber to the bypass valve and thereby open the bypass valve;

FIG. 15 is a cross section of the inlet guide vane assembly and controller similar to FIG. 11, but showing the valve pivoted into the vane-opening position, with the upper slot of the valve fluidly communicating with the return bore and the lower slot of the valve fluidly communicating with the supply bore;

FIG. 16 is a schematic view of the hydraulic assembly and controller shown in FIGS. 1-3, showing a pressure regulator, heat exchanger, pump, and sump of the hydraulic assembly, and showing the valve, actuator, pressure relief valve, and bypass valve of the controller;

FIG. 17 is a fragmentary cross section of an alternative compressor package constructed in accordance with a second embodiment of the present invention, with the controller including a diaphragm depicted schematically, showing the diaphragm attached to an arm of the sensor assembly and fluidly communicating with the compressor volute to sense compressor discharge pressure;

FIG. 18 is a graph showing an operational characteristic of the alternative compressor package without the diaphragm and operational characteristics of the alternative compressor package with the diaphragm installed in different configurations;

FIG. 19 is a schematic view of an alternative compressor package shown as part of a pneumatic conveying system constructed in accordance with a third embodiment of the present invention, with the system also including a media storage tank, main flow line, media valve, and downstream equipment, and with the compressor package including a centrifugal compressor, an inlet guide vane assembly, and a controller with an inlet guide vane actuator and a hydraulic valve;

FIG. 20 is a fragmentary perspective of the compressor package shown in FIG. 19, showing the centrifugal compressor, inlet guide vane assembly, and the actuator, with the actuator including an actuator housing and a double-acting piston, and showing the actuator housing sectioned to depict the piston and various fluid ports that fluidly communicate with opening and closing chambers on both sides of the piston;

FIG. 21 is a perspective of the hydraulic valve shown in FIG. 19, showing a valve housing, valve piston, and a shiftable lever, with the valve housing including a body, a cover, and a lever support;

FIG. 22 is a fragmentary schematic side elevation of the compressor package shown in FIG. 19, showing the hydraulic valve and a sensor assembly, with the sensor assembly including a pitot tube and diaphragm connected to the lever and the pitot tube, and showing another diaphragm connected to the lever and sensing static airflow pressure, with a weight attached to an opposite end of the lever;

FIG. 23 is a fragmentary schematic cross section of the hydraulic valve shown in FIGS. 21 and 22, showing a drain chamber of the housing and the valve piston extending along a bore of the valve housing, with the piston located in a neutral position where the valve restricts hydraulic fluid flow to and from the actuator;

FIG. 24 is a fragmentary schematic cross section of the hydraulic valve shown in FIGS. 21-23, showing the valve piston located in an opening position where hydraulic fluid is supplied to the opening chamber of the actuator and hydraulic fluid is drained from the closing chamber of the actuator;

FIG. 25 is a fragmentary schematic cross section of the hydraulic valve shown in FIGS. 21-24, showing the valve piston located in a closing position where hydraulic fluid is supplied to the closing chamber of the actuator and hydraulic fluid is drained from the opening chamber of the actuator;

FIG. 26 is a side elevation of the body of the valve housing shown in FIGS. 21-25, showing various laterally-extending ports including a relief port, upper and lower pairs of drain ports that extend through the piston bore and to the drain chamber, a supply port, and upper and lower return ports;

FIG. 27 is a cross section of the valve housing body taken along line 27-27 in FIG. 26;

FIG. 28 is a cross section of the valve housing body taken along line 28-28 in FIG. 26;

FIG. 29 is a cross section of the valve housing body taken along line 29-29 in FIG. 26;

FIG. 30 is a cross section of the valve housing body taken along line 30-30 in FIG. 26;

FIG. 31 is a cross section of the valve housing body taken along line 31-31 in FIG. 26;

FIG. 32 is a cross section of the valve housing body taken along line 32-32 in FIG. 26;

FIG. 33 is a cross section of the valve housing body taken along line 33-33 in FIG. 26;

FIG. 34 is a cross section of the valve housing body taken along line 34-34 in FIG. 26;

FIG. 35 is a flow diagram depicting a method of using the compressor package shown in FIG. 19;

FIG. 36 is a schematic view of an alternative compressor package shown as part of a pneumatic conveying system constructed in accordance with a fourth embodiment of the present invention, with the system also including a media storage tank, main flow line, media valve, and downstream equipment, and with the compressor package including a centrifugal compressor, an inlet guide vane assembly, and a controller with an inlet guide vane actuator, a PID controller, and a variable frequency drive;

FIG. 37 is a flow diagram depicting a method of using the compressor package shown in FIG. 36; and

FIG. 38 is a flow diagram depicting another method of using the compressor package shown in FIG. 36.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

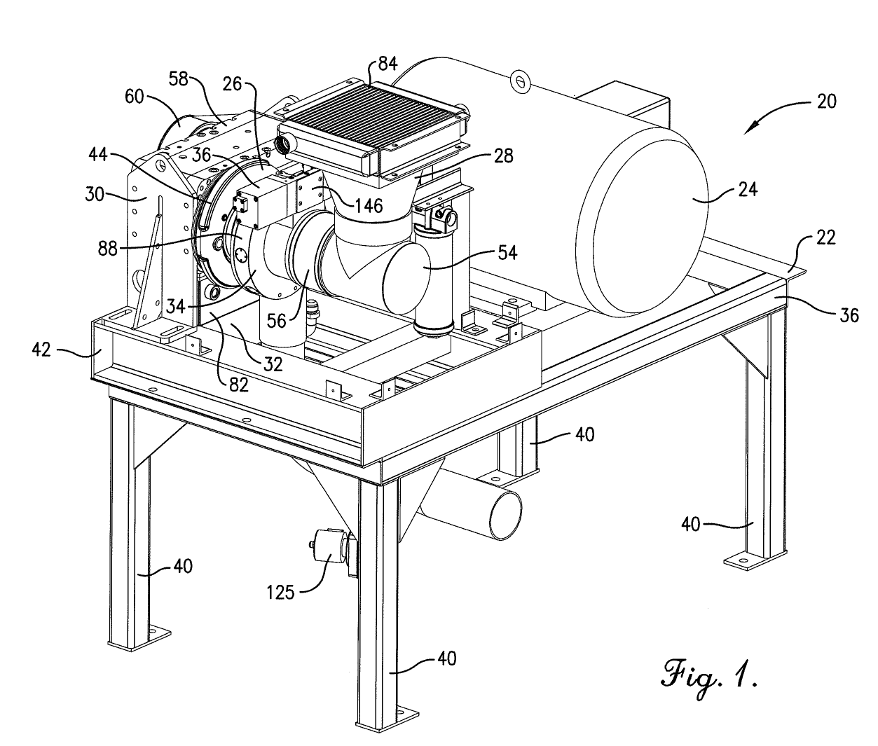

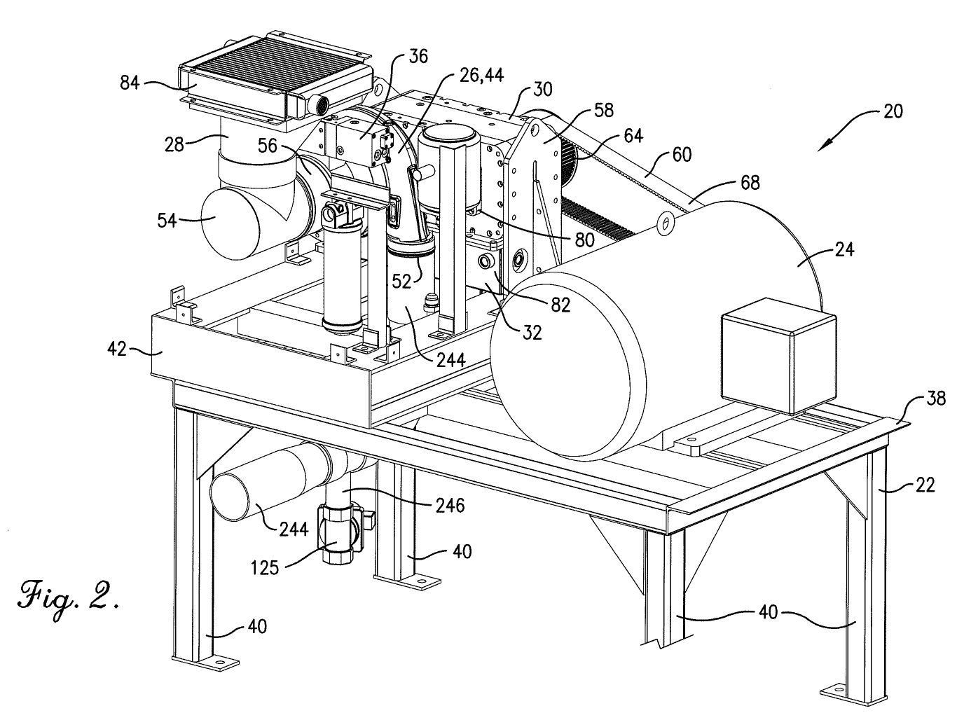

Turning initially to FIGS. 1 and 2, a modular compressor package 20 is illustrated for installation as part of a pneumatic conveying system to convey various types of particulate media. However, the compressor package 20 is capable of providing compressed air for other applications without departing from the scope of the present invention. Furthermore, the illustrated compressor package 20 is particularly suitable for use as a retrofit into a pneumatic conveying system in place of a positive-displacement compressor. It has been found that the compressor package 20 is operable to provide compressed air at a substantially uniform velocity, much like a positive-displacement compressor, while providing better overall compressor efficiency. The modular compressor package 20 broadly includes a base 22, a motor 24, a centrifugal compressor 26, an intake system 28, a transmission 30, a hydraulic assembly 32, an inlet guide vane assembly 34, and a guide vane controller 36.

Turning to FIGS. 1-3, the base 22 supports the rest of the compressor package 20. The base 22 includes an elevated frame 38 supported on upright legs 40 and a compressor platform 42 secured adjacent one end of the frame 38. In the usual manner, the elements of base 22 are preferably formed of steel, although the base 22 could include other materials. While the base 22 has components supported entirely by frame 38, the base 22 could have an additional frame spaced above or below frame 38 to alternatively support the package components.

The motor 24 provides power to the compressor package 20. The motor 24 comprises an electric motor that is drivingly attached to the transmission 30 in the usual manner. Another type of motor, such as an internal combustion engine, could be substituted for the electric motor without departing from the scope of the present invention.

Turning to FIGS. 1-4, the compressor 26 is a conventional centrifugal compressor and is operable to provide compressed air for various applications, such as pneumatic conveying. The compressor 26 includes a housing 44, an impeller shaft 46 rotatably mounted on the housing 44, and an impeller 48 mounted on the shaft 46 to rotate with the shaft 46. The housing 44 presents a chamber that rotatably receives the impeller 48 and presents an inlet 50 and a discharge 52. In the usual manner, the impeller 48 draws airflow into the housing 44 via the inlet 50 and provides compressed airflow through the discharge 52. As will be discussed, the inlet guide vane assembly 34 is attached the housing 44 upstream of the inlet 50.

The intake system 28 is attached to the compressor 26 and fluidly communicates with the inlet 50. The intake system 28 includes an air intake plenum 54 and flexible tube 56 that fluidly interconnects the plenum 54 and the inlet guide vane assembly 34. As will be discussed, a heat exchanger of the hydraulic assembly 32 is mounted to the inlet of plenum 54 to cool hydraulic fluid.

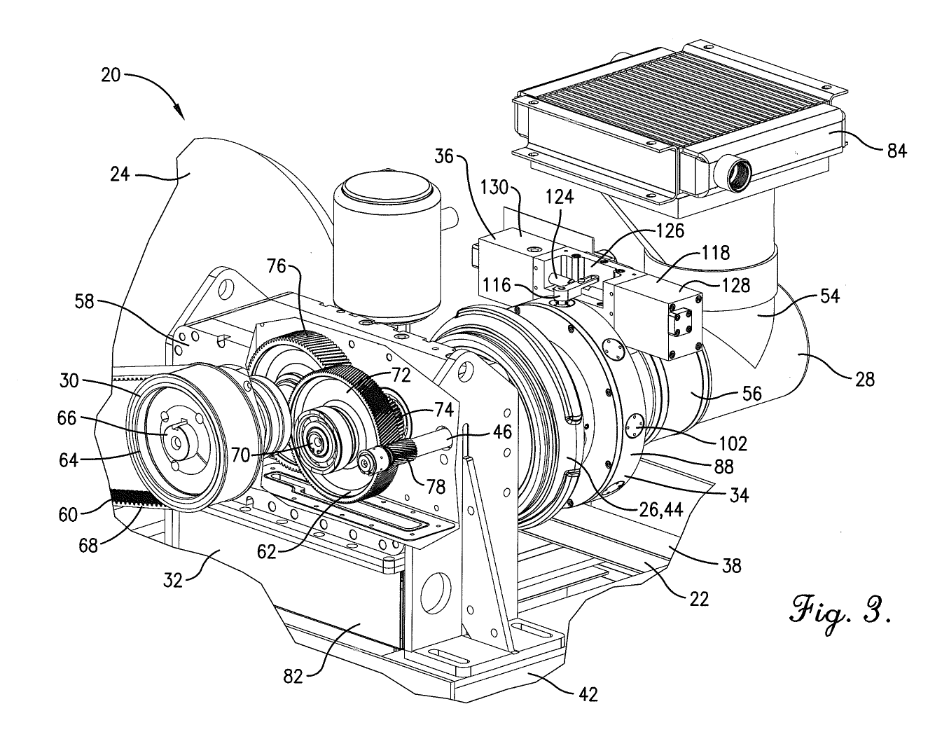

Turning to FIG. 3, the transmission 30 provides power from the motor 24 to the compressor 26 and the hydraulic assembly 32. The illustrated compressor package 20 is preferably configured so that the transmission 30 is generally external to the compressor 26. However, the principles of the present invention are applicable where the compressor 26 has an internal transmission. Furthermore, the transmission could be configured to provide self-lubrication. Preferred details of such a compressor and transmission arrangement are disclosed in U.S. Pat. No. 6,439,208, issued Aug. 27, 2002, entitled CENTRIFUGAL SUPERCHARGER HAVING LUBRICATING SLINGER, which is hereby incorporated in its entirety by reference herein.

The transmission 30 preferably includes a housing 58, an external belt drive 60, and an internal gear drive 62. The belt drive 60 includes a drive sheave (not shown) mounted on the shaft of the motor 24, a driven sheave 64 mounted on an input shaft 66 of the gear drive 62, and a toothed belt 68 drivingly entrained on the sheaves so that the motor 24 powers the input shaft 66.

The gear drive 62 includes the input shaft 66 and an intermediate shaft 70. The gear drive 62 further includes a drive gear (not shown) mounted on the input shaft 66. Gears 72,74 are mounted on the intermediate shaft 70. The gear drive 62 further includes a driven gear 76 mounted to a drive shaft (not shown) of a hydraulic positive-displacement pump of the hydraulic assembly 32. The gear drive 62 also includes a driven gear 78 mounted on the impeller shaft 46.

The transmission 30 provides power to the impeller 48 by transmitting power from the motor 24 to the input shaft 66. Power is then transmitted to gear 72 and to driven gear 78, which is drivingly mounted on the impeller shaft 46. The gears 72,78 are preferably sized to provide a step-up arrangement to increase the rotational speed of the compressor 26, although an alternative drive configuration could be employed to power the impeller 48

The transmission 30 provides power to the hydraulic pump by transmitting power through the belt drive 60 to the input shaft 66. Power is then transmitted to gear 72 and intermediate shaft 70. Power is further transmitted from the gear 74 to the driven gear 76 mounted on the pump shaft. The gears 74,76 preferably provide a step-down arrangement to decrease the rotational speed of the hydraulic pump, although an alternative drive could be used to power the pump.

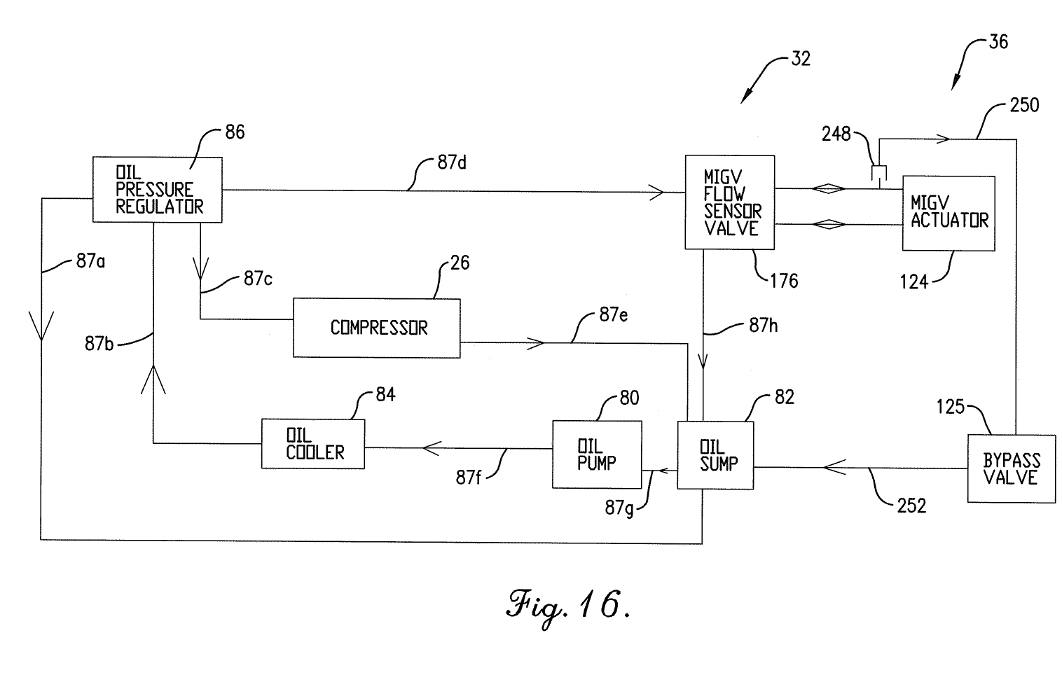

Turning to FIGS. 1-3 and 16, the hydraulic assembly 32 provides lubricant to transmission 30 and also provides hydraulic power to the controller 36. The hydraulic assembly 32 broadly includes a hydraulic pump 80, a sump 82, a heat exchanger 84, and a pressure regulator 86, with hydraulic lines 87a,b,c,d,e,f,g,h fluidly connecting the components. (see FIG. 16). The pump 80 is preferably a conventional positive-displacement hydraulic pump and includes a pump drive shaft (not shown). The pump 80 is mounted on a sidewall of the housing 58. The pump drive shaft extends through the sidewall into the transmission chamber and receives the driven gear 76 so that the driven gear 76 rotates with the drive shaft.

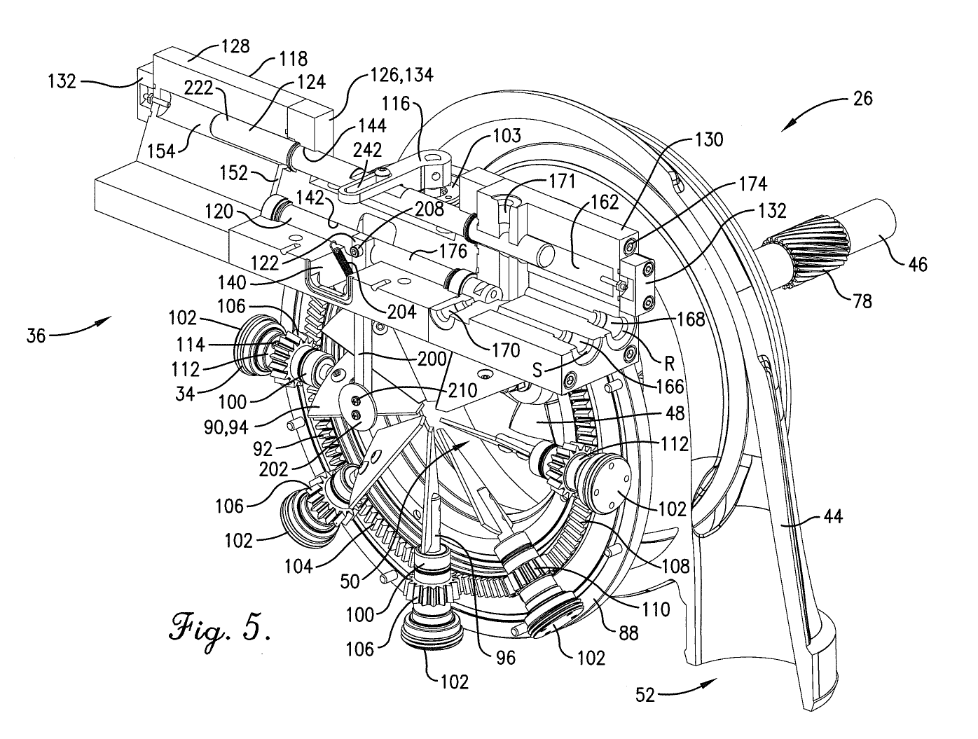

Turning to FIGS. 5, 6, 12, and 14, the inlet guide vane assembly 34 controls airflow drawn through the inlet 50 of compressor 26. The inlet guide vane assembly 34 broadly includes a two-piece annular housing 88, a plurality of vanes 90 rotatably mounted in the housing 88, and a gear assembly 92. The housing 88 preferably includes two annular housing sections that are removably attached to one another and cooperatively form an annular chamber that receives the vanes 90 and gear assembly 92. The housing 88 is removably attached to the housing of compressor 26 adjacent the inlet 50. However, it is also within the scope of the present invention where the housing 88 is alternatively constructed. Yet further, the assembly 34 could be configured so that housing 88 is eliminated, e.g., where the assembly 34 is integrated into the compressor housing.

The vanes 90 each preferably include a flat vane body 94 and a shaft 96 attached to the body 94 with fasteners. The principles of the present invention are also applicable where the body 94 takes a different shape, e.g., another shape that provides improved vane performance.

The vanes 90 are pivotally mounted in the housing 88 and are spaced circumferentially about a passage 98 that extends through the housing and toward the impeller 48. The inlet guide vane assembly 34 further includes bearings 100 that rotatably receive corresponding shafts 96. Furthermore, the assembly 34 includes caps 102,103 that are attached to and are rotatable with corresponding shafts 96. The illustrated assembly 34 preferably includes eight vanes 90, although a larger or smaller number of vanes 90 could be used to provide suitable vane performance.

The gear assembly 92 drivingly interconnects the vanes 90 with one another so that the vanes 90 are synchronously shiftable. The gear assembly 92 broadly includes a ring gear 104 and pinion gears 106 positioned along the length of the ring gear 104. The ring gear 104 presents an endless toothed surface 108 that generally faces in an axial direction. The ring gear 104 is rotatably mounted within an annular groove of the housing 88 so that the toothed surface 108 generally faces forwardly. The gear assembly 92 also includes an annular bushing (not shown) and a wave spring (not shown) received between the ring gear 104 and groove. In particular, the bushing is positioned between the ring gear 104 and wave spring, with the wave spring engaging the base of the groove. Thus, the wave spring urges the ring gear 104 into engagement with pinion gears 106.

The pinion gears 106 each have a toothed body 110 and a sleeve 112 integrally formed with the body 110. The sleeve 112 receives a threaded set screw 114. The teeth of body 110 present a pinion diameter that tapers from adjacent the sleeve 112 to an end of the pinion gear 106 opposite the sleeve 112. Preferably, the pinion diameter presents a taper angle relative to the rotational axis of the pinion gear 106 that ranges from about five (5) degrees to about six (6) degrees, although the pinion gears 106 could be alternatively configured.

The pinion gears 106 are mounted on corresponding shafts 96 of the vanes 90, and each gear 106 is positioned between the respective bearing 100 and cap 102. The gears 106 are preferably secured by threading set screw 114 into engagement with shaft 96. Thus, the gears 106 are preferably spaced about the circumference of the ring gear 104. It has been found that this arrangement of gears 106 and the tapered pinion construction allow the pinion gears 106 to cooperatively maintain the ring gear 104 centered relative to the gears 106.

Again, the vanes 90 are spaced about the passage 98, and the pinion gears 106 each engage the toothed surface 108. One of the shafts 96 extends radially outwardly from the cap 103 and is attached to a swing arm 116. Thus, rotation of the swing arm 116 causes rotation of the shaft 96 and pinion gear 106 attached to the swing arm 116. Because the pinion gears 106 intermesh with the ring gear 104, this movement causes rotation of the ring gear 104 about the passage 98 and corresponding pivotal movement of the other pinion gears 106. Thus, the pinion gears 106 and vanes 90 move synchronously with one another. Furthermore, each gear 106 and vane 90 rotates in the same rotational direction as the other gears 106 and vanes 90. The rotational direction of a vane 90 is determined from a corresponding fixed reference point on the housing 88. Thus, if one vane 90 is rotated in a clockwise direction, the other vanes 90 also rotate in the clockwise direction at the same time.

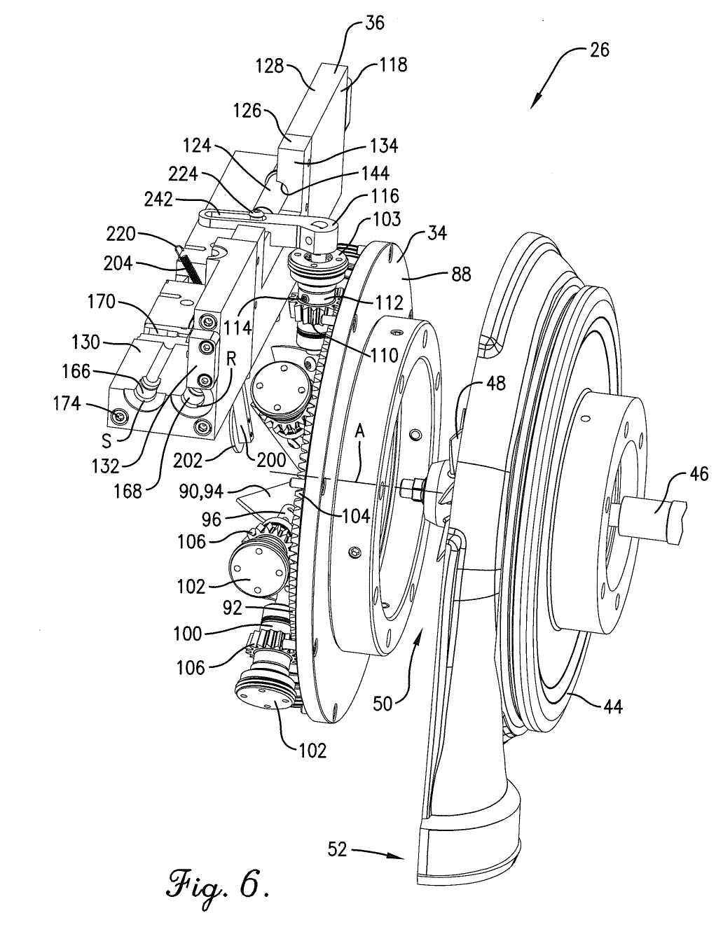

Turning to FIG. 6, the vanes 90 can preferably be positioned relative to a passage axis A to provide either preswirl or counterswirl to the incoming airflow, or to impart substantially no swirling motion to the air flow. The preswirl direction coincides with the rotational direction of the impeller 48 and is clockwise when viewing the impeller 48 along the passage axis A. Thus, the counterswirl direction is counterclockwise when viewing the impeller 48 along the passage axis A. When the vanes 90 are in a neutral condition (i.e., the vanes 90 impart no preswirl or counterswirl), the vanes 90 are arranged so that the plane of vane body 90 is aligned with the passage axis A.

The vanes 90 can be rotated clockwise from the neutral condition into a maximum preswirl condition. In the illustrated maximum preswirl condition, the vanes 90 are preferably rotated to an angle of about eighty (80) degrees clockwise from the axis A and the passage 98 is almost fully occluded. However, as will be discussed, the controller 36 can be adjusted to provide an alternative vane preswirl position associated with maximum preswirl. Similarly the vanes 90 can be rotated counterclockwise from the neutral condition into a maximum counterswirl condition. In the illustrated maximum counterswirl condition, the vanes 90 are preferably rotated to an angle of about fifteen (15) degrees counterclockwise from the axis A. Again, the controller 36 can be adjusted to provide an alternative vane counterswirl position associated with maximum counterswirl. However, for some applications, the controller 36 can also be adjusted so that the vanes 90 are not shiftable into any counterswirl position, i.e., the vanes 90 are always in a preswirl position or the neutral condition.

The illustrated vanes 90 are preferably arranged upstream of inlet 50 to provide preswirl of incoming airflow. However, the principles of the present invention are applicable where vanes are employed to control the discharge flow of compressor 26. For instance, the compressor 26 could include vanes mounted into the diffuser of compressor 26. Alternatively a vane arrangement similar to the illustrated vane assembly 34 could be located downstream of the compressor discharge 52. For some aspects of the present invention, the compressor package 20 could employ an alternative valve-type mechanism to control compressor airflow. For instance, some types of valves (such as a butterfly valve) could be installed upstream or downstream of the compressor 26 and used to throttle compressor airflow.

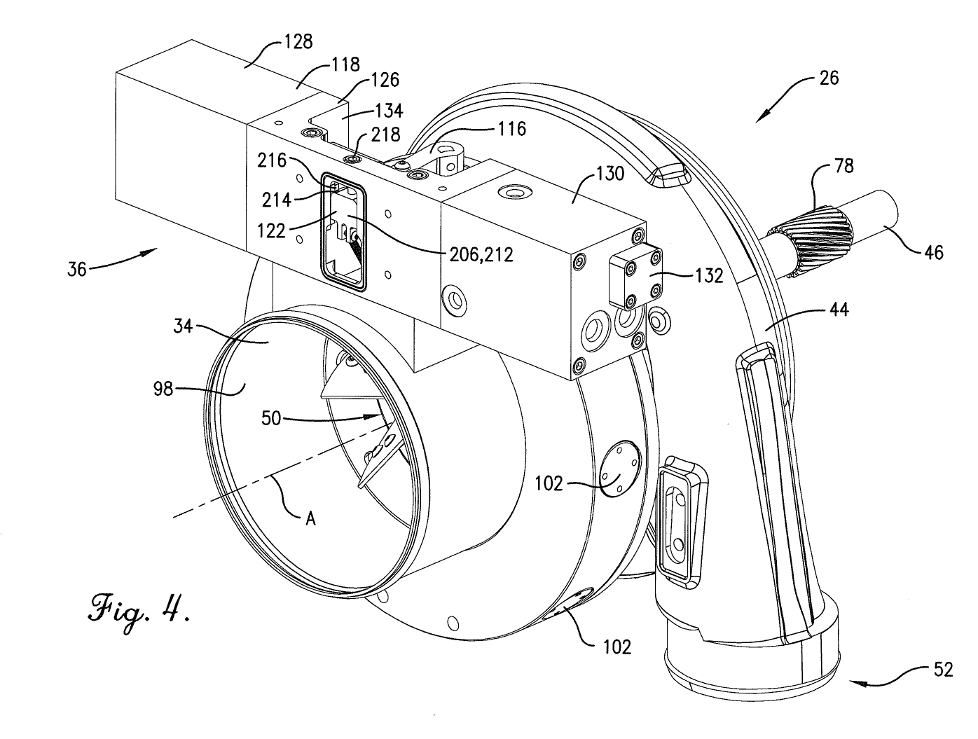

Turning to FIGS. 4-10, the illustrated controller 36 is operable to position the vanes 90 of assembly 34 so that the compressor 26 provides a compressed airflow with a substantially constant velocity. It has been found that such operation is desirable in various compressor applications, such as pneumatic conveying. The controller 36 broadly includes a controller housing assembly 118, a valve assembly 120, a velocity sensor assembly 122, a hydraulically-driven actuator 124, and a bypass valve 125.

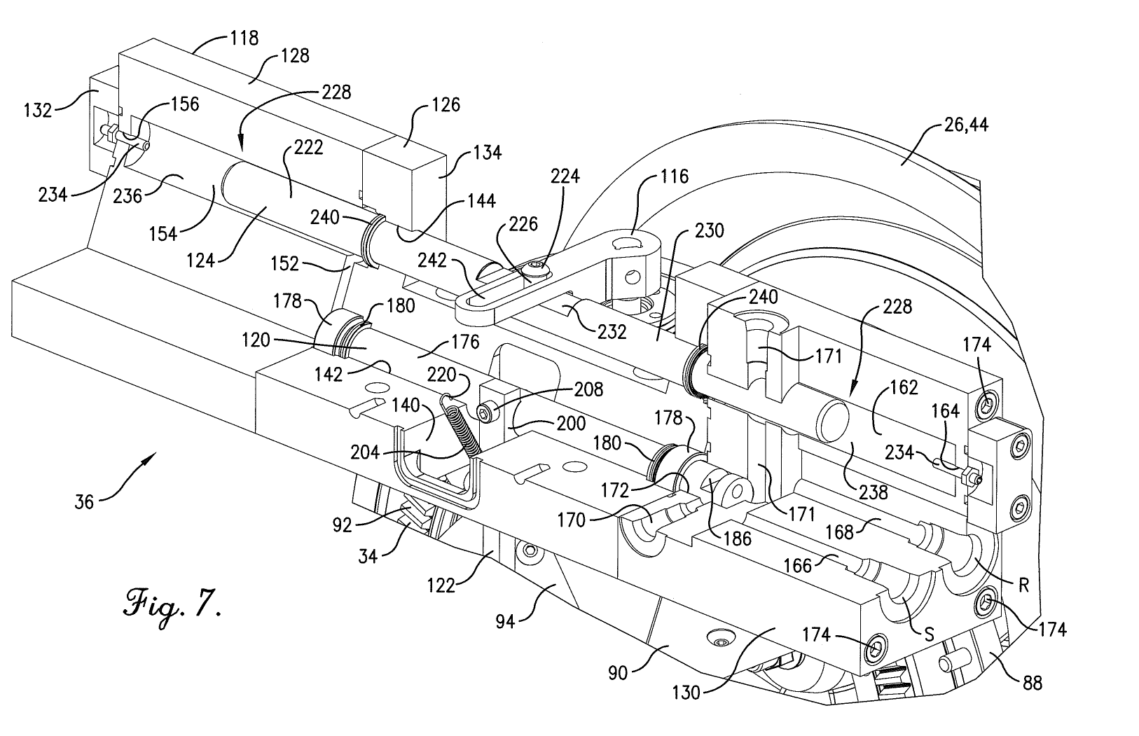

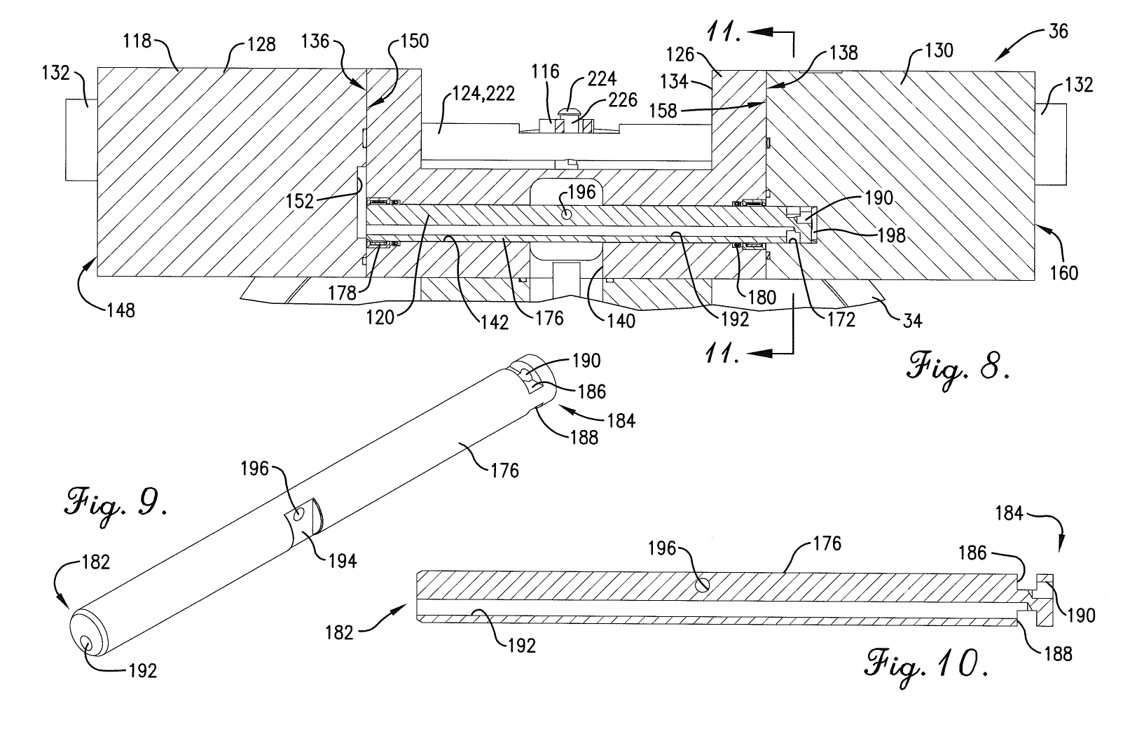

The housing assembly 118 preferably includes a central housing 126, end manifolds 128,130, and end caps 132. The central housing 126 includes a generally rectangular cuboid body that presents an open rear slot 134 spaced between ends of the housing 126 (see FIGS. 7 and 8), end faces 136,138 (see FIG. 8), a centrally-located bottom cavity 140 that opens to front and bottom faces of the housing 126, and transverse valve and piston bores 142,144 that extend laterally between the end faces 136,138. The central housing 126 also includes a cover plate 146 that is removably attached to the body with fasteners. The cover plate 146 covers the bottom cavity 140 along the front face (see FIGS. 1 and 11).

The end manifold 128 comprises a generally rectangular cuboid body and presents end faces 148,150 (see FIG. 8). The end face 150 includes a slot 152 spaced from the outer margin of the end face 150 (see FIG. 7). A piston end bore 154 extends from the slot 152 toward the end face 148, with a threaded hole 156 extending from the end face 148 to the bore 154.

The end manifold 128 is removably attached to the central housing 126 with fasteners that extend through the body of manifold 128 and are threaded into the central housing 126. With the end manifold 128 attached to the central housing 126, the end face 150 engages the end face 136 of central housing 126 (see FIG. 8). Also, the piston end bore 154 is preferably aligned with the piston bore 144 (see FIG. 7). Furthermore, the recess presented by the slot 152 preferably fluidly communicates with the valve bore 142 (see FIG. 8).

The end manifold 130 also comprises a generally rectangular cuboid body and presents end faces 158,160 (see FIG. 8). A piston end bore 162 extends from end face 158 toward the end face 160, with a threaded hole 164 extending from the end face 160 to the bore 162. The end manifold 130 also presents transversely extending supply and return bores 166,168 extending from the end face 160 toward the end face 158. A fore-and-aft bore 170 extends from the front face of end manifold 130 to the return bore 168. An upright bore 171 extends from the top face of end manifold 130 to a valve end bore 172. Once the bores 170,171 are machined, the open ends of the bores 170,171 are closed with plugs (not shown) to prevent fluid leakage from the bores 170,171.

The end manifold 130 is removably attached to the central housing 126 with fasteners 174 that extend through the body of manifold 130 and are threaded into the central housing 126. With the end manifold 130 attached to the central housing 126, the end face 158 engages the end face 138 of central housing 126 (see FIG. 8). Also, the piston end bore 162 is preferably aligned with the piston bore 144 (see FIG. 7). Furthermore, the valve end bore 172 is preferably aligned with the valve bore 142 (see FIG. 8).

The housing assembly 118 is preferably removably mounted on a platform of the housing 88, with the housing assembly 118 being located above the passage 98 and located forwardly of the vanes 90. However, the housing assembly 118 could be alternatively supported relative to the inlet guide vane assembly 34.

The central housing and end manifolds 128,130 of the housing assembly 118 are preferably formed of aluminum, but could be formed of other materials, such as stainless steel or carbon steel. Yet further, the components of housing assembly 118 could be alternatively configured to provide suitable controller operation.

The hydraulic assembly 32 and housing assembly 118 are fluidly connected to one another so that pressurized hydraulic fluid can be supplied to the controller 36 and returned from the controller 36. In particular, line 87d runs from the pressure regulator 86 to supply port S so that pressurized hydraulic fluid can flow to supply bore 166. Line 87h runs from return port R to sump 82 so that pressurized hydraulic fluid can be returned from return bore 168. While the controller 36 is preferably hydraulically powered, for some aspects of the present invention the controller 36 could be pneumatically operated.

Turning to FIGS. 7-10, the valve assembly 120 serves to control and selectively allow hydraulic fluid flow within the controller 36. The valve assembly 120 includes a rotatable valve 176, bearings 178, and seals 180. The valve 176 preferably comprises a unitary and cylindrical metal body that presents a chamfered end 182 and a slotted end 184 (see FIGS. 9 and 10). The valve 176 presents upper and lower slots 186,188 that extend perpendicular to the length of the valve 176 and along the end 184. An upper longitudinal bore 190 extends from the end 184 to the upper slot 186. A lower longitudinal bore 192 extends from the end 182 to the lower slot 188. The valve 176 further presents a centrally spaced fore-and-aft slot 194 and a through hole 196.

The valve 176 is rotatably received within the valve bore 142 and valve end bore 172. In particular, the chamfered end 182 is positioned adjacent the end face 136 and the slotted end 184 is located within the valve end bore 172 so that a gap 198 is defined between the slotted end 184 and the end of the valve end bore 172 (see FIG. 8).

Bearings 178 are secured in annular slots formed adjacent to and surrounding corresponding ends of the valve bore 142. The bearings 178 rotatably receive and support the valve 176 within the housing assembly 118 and permit rotation relative thereto. A pair of seals 180 are received in corresponding glands that surround the valve bore 142 and are located between the annular bearing slots. The seals 180 rotatably engage the valve 176 and restrict pressurized fluid from flowing from the recess of slot 152 to the bottom cavity 140 and from the valve end bore 172 to the bottom cavity 140. Preferably, the seals 180 are formed of PTFE material to provide low friction, although other materials could be used.

Turning to FIGS. 7 and 11-15, the valve 176 is operable to control hydraulic fluid flow within the controller 36 by selectively allowing hydraulic fluid to flow between piston end bores 154,162 and the supply and return bores 166,168. In a closed position, the valve 176 is positioned so that neither of the slots 186,188 is in fluid communication with the fore-and-aft bore 170 (see FIGS. 7 and 11). The fore-and-aft bore 170 provides part of the paths for fluid to flow between the bores 166,168 and piston end bores 154,162. Thus, the closed valve 176 prevents fluid flow into and out of the controller 36.

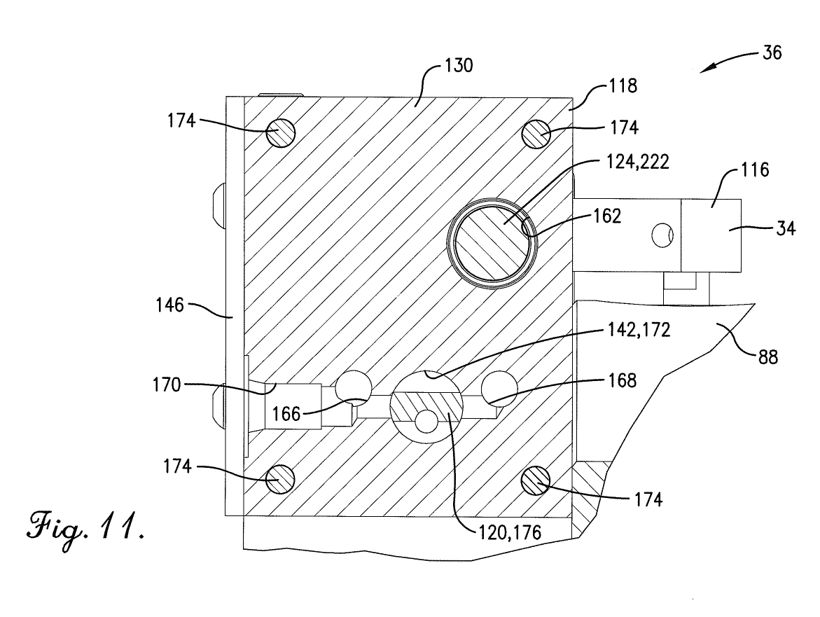

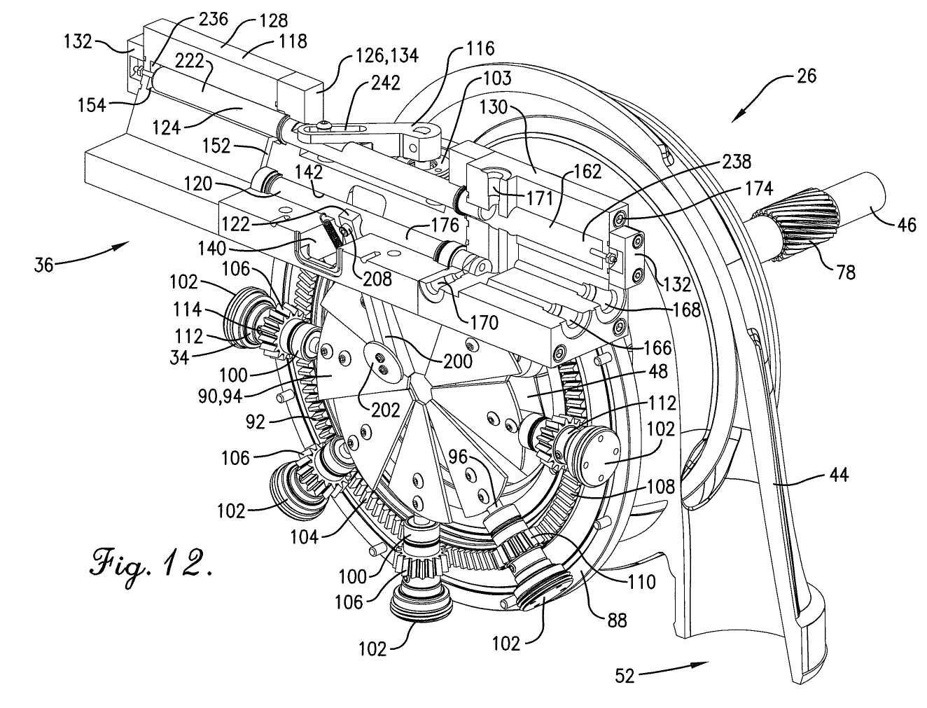

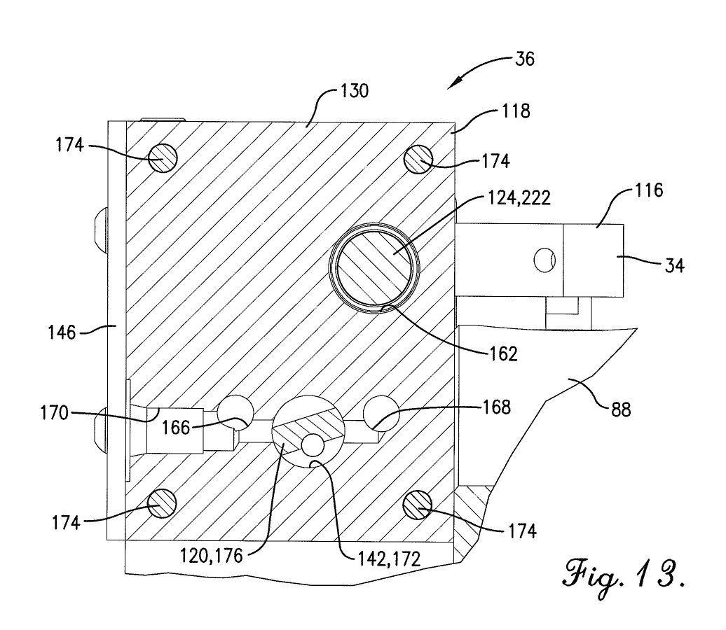

In a vane-closing position, the valve 176 is positioned so that the upper slot 186 fluidly communicates with the supply bore 166 via a front portion of the fore-and-aft bore 170, and the upper slot 186 thereby receives pressurized supply fluid (see FIGS. 12 and 13). The piston end bore 162, upright bore 171, gap 198, and upper bore 190 are also in fluid communication with the upper slot 186 and also receive pressurized supply fluid.

At the same time, in the vane-closing position, the lower slot 188 fluidly communicates with the return bore 168 via a rear portion of the fore-and-aft bore 170, and the lower slot 188 thereby returns pressurized supply fluid. The piston end bore 154, slot 152, and lower bore 192 are also in fluid communication with the lower slot 188 to thereby return pressurized supply fluid in the vane-closing position.

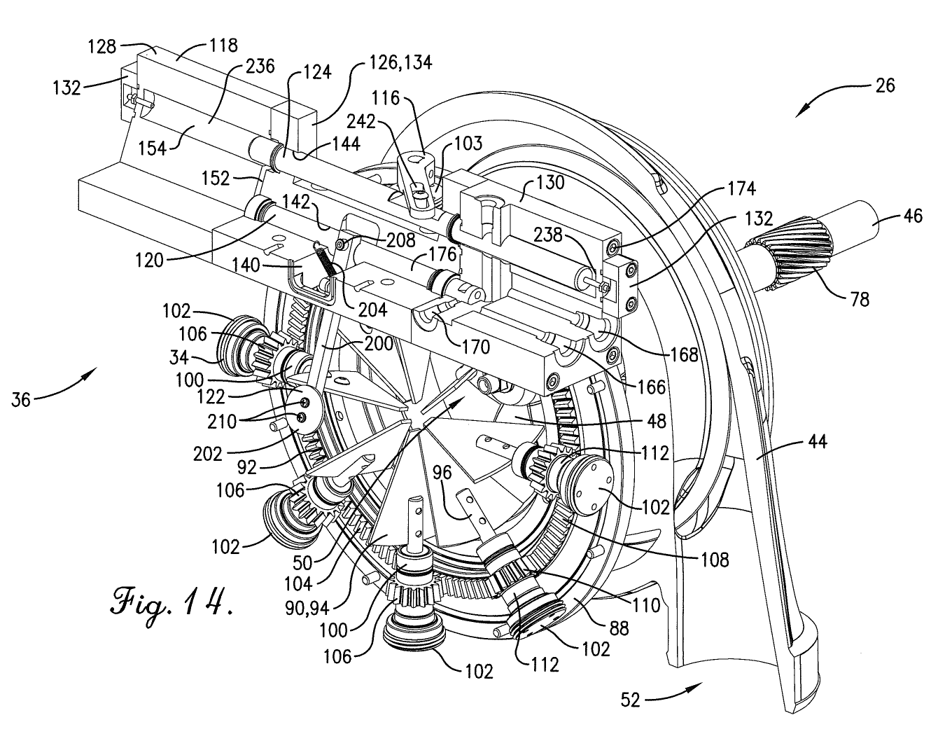

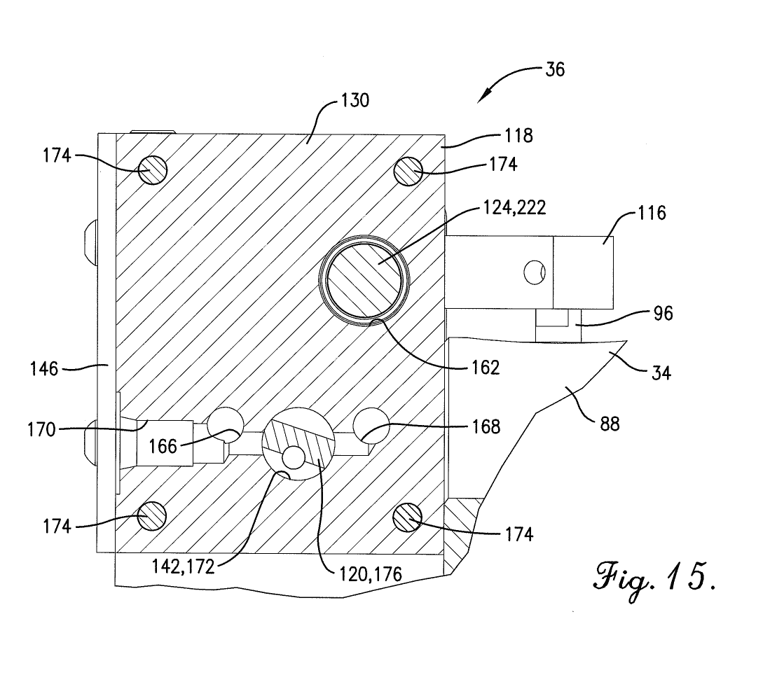

In a vane-opening position, the valve 176 is positioned so that the lower slot 188 fluidly communicates with the supply bore 166 via the front portion of the fore-and-aft bore 170, and the lower slot 188 thereby receives pressurized supply fluid (see FIGS. 14 and 15). Again, the piston end bore 154, slot 152, and lower bore 192 are in fluid communication with the lower slot 188 and also receive pressurized supply fluid.

At the same time, in the vane-opening position, the upper slot 186 fluidly communicates with the return bore 168 via the rear portion of the fore-and-aft bore 170, and the upper slot 186 thereby returns pressurized supply fluid. Again, the piston end bore 162, upright bore 171, gap 198, and upper bore 190 are in fluid communication with the upper slot 186 and also return pressurized supply fluid in the vane-opening position. In this manner, the illustrated vane arrangement simultaneously pressurizes and depressurizes opposite sides of the illustrated hydraulic piston, as will be discussed.

The illustrated valve assembly 120 preferably comprises a mechanically-driven fluid valve. However, for some aspects of the present invention, the valve assembly 120 could include an alternatively-driven valve arrangement, such as an electronic solenoid valve.

The velocity sensor assembly 122 is shiftably received in the passage 98 and is operable to rotate the valve 176. The velocity sensor assembly 122 broadly includes an elongated arm 200, a plate 202, a spring 204, and an adjuster 206. The arm 200 presents opposite ends, with an upper end being removably attached to the valve 176 within the central slot 194 by a threaded fastener 208. The plate 202 is generally circular and is removably attached to a lower end of the arm 200 by screws 210 (see FIG. 5). The arm 200 and plate 202 preferably take the illustrated shape, but it is also within the ambit of the present invention where the arm 200 and plate 202 have alternative shapes to provide desired sensor operation. For example, the plate 202 could have a larger or smaller diameter so that the plate 202 applies a correspondingly larger or smaller drag force to the arm 200 when airflow is rushing past the sensor.

With the arm 200 secured to the valve 176, the valve 176, arm 200, and plate 202 are operable to pivot with one another about a lateral axis. Again, the valve 176 pivots to direct pressurized fluid through the controller 36. The sensor assembly 122 serves to operate the valve 176, as will be discussed below.

Turning to FIG. 4, the adjuster 206 provides tension adjustment of the spring 204. The adjuster 206 includes a slotted body 212 with opposite end slots 214. The body 212 is slidably received by complemental grooves 216 that form part of the bottom cavity 140 of the central housing 126. Thus, the body 212 is operable to slide up and down within the cavity 140. The body 212 is adjustably positioned by a tensioning screw 218 that extends through a hole in the central housing 126 and is rotatably received by the body 212.

The spring 204 includes opposite end hooks 220, with one end hook 220 removably attached to the arm 200 at a location preferably about one-third of the arm length from the upper arm end. The other end hook 220 is removably attached to the body 212 (see FIG. 7). The illustrated adjuster 206 is spaced in front of and above the arm 200 so that the spring 204 urges the arm 200 in a forward direction, i.e., generally opposite the normal airflow direction into the inlet 50. However, the sensor assembly 122 could have an alternative construction to provide adjustment of the valve 176. For instance, the assembly 122 could have one or more alternative springs to control positioning of the arm 200.

Furthermore, the sensor assembly 122 could include a traditional damping mechanism, such as a fluid-filled damper, connected between the arm 200 and housing 126 to provide additional control of the valve 176. However, one of ordinary skill will appreciate that suitable damping of the valve 176 and actuator 124 can be provided by various alternative constructions. Furthermore, some damping of the controller 36 is provided inherently by the hydraulic arrangement of the controller 36. That is, the hydraulic fluid within the controller 36 provides some damping of the actuator 124, valve 176, and fluid pressure signals transmitted therebetween.

In the illustrated embodiment, the spring 204 urges the arm 200 so that the valve 176 assumes the closed position when the airflow is at a predetermined airflow velocity; that is, the arm 200 is preferably held by the spring somewhere between the extreme positions during “ideal” operating conditions. However, the adjuster 206 is operable to change the spring tension (and thereby the length of spring 204) to vary the predetermined airflow velocity that corresponds to the valve 176 in the closed position. In particular, as the adjuster 206 is shifted upwardly to provide greater spring tension, the predetermined airflow velocity associated with the closed valve position generally increases. As the adjuster 206 is shifted downwardly to decrease spring tension, the predetermined airflow velocity associated with the closed valve position generally decreases.

Preferably, the illustrated sensor assembly 122 is primarily responsive to airflow velocity through the passage 98. However, as will be shown in a subsequent embodiment, the controller can be alternatively configured to include a diaphragm attached to the arm 200, where the diaphragm senses compressor discharge pressure and applies a force to the arm 200 in response to the pressure.

The illustrated sensor assembly 122 preferably comprises a mechanical velocity sensor. However, for some aspects of the present invention, an alternative velocity or mass flow sensor, such as a pitot tube or hot wire anemometer, could be used to determine airflow velocity for the compressor package 20. As discussed above, the valve assembly 120 could include an alternative valve, such as an electronic solenoid valve. For some aspects of the present invention, the compressor package 20 could utilize a solenoid valve in combination with an electronic velocity sensor to alternatively sense airflow and provide fluid control of the inlet guide vanes.

Turning to FIG. 7, the hydraulically-driven actuator 124 serves to drive the swing arm 116. The actuator 124 preferably includes a piston 222, a screw 224, and a bushing 226. The piston 222 preferably comprises a unitary cylindrical rod that presents opposite ends 228, a smooth cylindrical surface 230, and a central flat 232 spaced between the ends 228.

The piston 222 is reciprocally received in piston bore 144 and end bores 154,162 so as to be slidable between left and right endmost positions corresponding to the vanes 90 in the maximum preswirl condition and the maximum counterswirl condition (see FIGS. 12 and 14). In each endmost position, the piston 222 contacts a corresponding stop 234, which comprises a threaded screw that is adjustably positionable to change the location of the endmost position. Thus, the left stop 234 can be adjusted to provide an alternative vane preswirl position associated with maximum preswirl. Also, the right stop 234 can be adjusted to provide an alternative vane counterswirl position associated with maximum counterswirl. Again, for some applications, the right stop 234 can also be adjusted so that the vanes 90 are not shiftable into any counterswirl position, i.e., the vanes 90 are always in a preswirl position or the neutral condition. The stops 234 are covered by end caps 132 secured to the respective end manifold with fasteners. The stops 234 can be selectively accessed for adjustment by removing the respective end cap 132.

The piston 222 and end bores 154,162 cooperatively form corresponding fluid chambers 236,238 that receive pressurized fluid. The illustrated piston 222 is preferably a double-acting piston, although the controller 36 could be configured so that the piston 222 is single-acting without departing from the scope of the present invention. Low-friction seals 240 are located at corresponding ends of the central housing 126 and extend around the piston 222 to hold fluid within the chambers 236,238. Preferably, the seals 240 are formed of PTFE material to provide low friction, although other materials could be used.

The piston 222 is removably attached to the swing arm 116 by inserting the screw 224 and bushing 226 through a slot 242 in the swing arm 116. Thus, as the piston 222 reciprocates between the endmost positions, the screw 224 and bushing 226 slide along the slot 242. Thus, the swing arm 116 pivots in a manner corresponding to sliding movement of the piston 222.

As discussed above, pivotal movement of the swing arm 116 causes corresponding pivotal movement of the vanes 90. Thus, sliding movement of the piston 222 results in corresponding pivotal movement of the vanes 90. With the piston 222 in the left endmost position, the vanes 90 are shifted to the maximum preswirl condition (see FIG. 12). With the piston 222 in the right endmost position, the vanes 90 are shifted to the maximum counterswirl condition (see FIG. 14).

The actuator 124 uses hydraulic fluid from the hydraulic system to power the vanes 90 depending on the position of valve 176. As discussed above, the valve 176 has a closed position and opposite open positions (i.e., the vane-opening position and the vane-closing position).

In the vane-closing position, the valve 176 is positioned so that the upper slot 186 fluidly communicates with the supply bore 166 (see FIG. 12). Consequently, the piston end bore 162 is in fluid communication with the upper slot 186 to receive pressurized supply fluid and fill the fluid chamber 238. At the same time, the lower slot 188 fluidly communicates with the return bore 168. Thus, the piston end bore 154 is in fluid communication with the lower slot 188 to return pressurized supply fluid in the vane-opening position and thereby empty the fluid chamber 236. The simultaneous filling and emptying of chambers 236,238 causes the piston 222 to shift to the left, with the vanes 90 shifting to the maximum preswirl condition (see FIG. 12).

In the vane-opening position, the valve 176 is positioned so that the lower slot 188 fluidly communicates with the supply bore 166. The piston end bore 154 is in fluid communication with the lower slot 188 to receive pressurized supply fluid and fill the fluid chamber 236. At the same time, the upper slot 186 fluidly communicates with the return bore 168. The piston end bore 162 is in fluid communication with the upper slot 186 to return pressurized supply fluid in the vane-closing position and thereby empty the fluid chamber 238. This simultaneous filling and emptying of chambers 236,238 causes the piston 222 to shift to the right, with the vanes 90 shifting to the maximum counterswirl condition (see FIG. 14).

The inlet guide vane assembly 34 and controller 36 are depicted with the piston 222 and vanes 90 in certain discrete positions. Specifically, the piston 222 is shiftable between endmost positions with the vanes 90 being shiftable between maximum preswirl and maximum counterswirl conditions. However, it will be appreciated that the illustrated piston 222 can position the vanes 90 into nearly an infinite number of intermediate positions between the maximum preswirl and maximum counterswirl conditions. As discussed above, the piston 222 is slidable continuously along a lateral direction between the endmost positions. Also, the piston 222 is slidably attached to the swing arm 116. Thus, continuous sliding movement of piston 222 between the endmost positions results in corresponding pivotal movement of the swing arm 116, which causes synchronized continuous pivotal movement of vanes 90 between the maximum preswirl and maximum counterswirl conditions.

The illustrated actuator 124 preferably receives hydraulic fluid to drive the inlet guide vanes. However, for some aspects of the present invention, the actuator 124 could be alternatively configured to receive hydraulic fluid and power the inlet guide vanes. For instance, an alternative actuator could include a hydraulic motor that receives a continuous hydraulic fluid flow from the hydraulic system.

The illustrated controller 36 is preferably powered by the hydraulic system so that the hydraulic system amplifies the power input to the sensor assembly (caused by airflow in the passage 98) and thereby drives the actuator 124 and guide vanes 90. Through the direct mechanical connection between the sensor assembly and the valve 176, the sensor assembly directly effects positioning of the actuator 124 and thereby the vanes 90. For some aspects of the present invention, the controller 36 could be configured so that actuator 124 is powered by a conventional pneumatic power system, such as a regulated shop-air system.

The compressor package 20 provides substantially uniform airflow velocity by sensing the airflow and then shifting the inlet guide vanes, if necessary, to maintain a desired airflow velocity. For instance, in the illustrated embodiment, the compressor package 20 could maintain airflow velocity with a preset amount of preswirl (see FIG. 7).

In some instances, the compressed airflow discharged from the compressor 26 can encounter significant backpressure, such as when the package 20 is used in a pneumatic conveying system and a large volume of particulate matter is injected downstream of the compressor discharge. In such an instance, airflow velocity through the compressor 26 will decrease and the spring 204 will cause the sensor arm 200 to shift forwardly (i.e., away from the impeller) so that the valve 176 shifts into the vane-opening condition, which causes the vanes 90 to open. Thus, the vanes 90 open so that the inlet guide vane assembly 34 provides minimal restriction to intake airflow and thereby permits airflow velocity to increase and return to the desired airflow velocity.

Preferably, the bypass valve 125 is also operable to provide increased compressor airflow by venting compressed airflow from the compressor discharge to ambient. The illustrated bypass arrangement has been found to be particularly effective for low velocity conditions in pneumatic conveying systems when a large volume of particulate matter causes excessive backpressure in the compressor 26. The bypass valve 125 is mounted on main compressed air line 244 that runs from the compressor discharge 52. A bypass line 246 is fluidly connected to the main line 244 and terminates at the bypass valve 125. The bypass valve 125 receives pressurized hydraulic fluid from the housing assembly 118 via a pressure relief valve 248 and line 250 and returns hydraulic fluid to the sump 82 via line 252 (see FIG. 16).

When the compressor package 20 encounters a low airflow velocity due to substantial compressor backpressure, e.g., due to clogging of a pneumatic conveying line downstream of the compressor, the controller 36 initially opens the inlet guide vanes to reduce the intake airflow restriction of the inlet guide vane assembly and thereby allow greater airflow into the compressor 26. Again, the controller 36 opens the vanes 90 in a low velocity condition because the sensor arm 200 pivots forwardly and the valve 176 pivots so that pressurized fluid builds in the chamber 236 to shift the piston 222 to the right (see FIG. 14). In the event that the valve 176 remains in the vane-opening position because of continued low-velocity airflow, fluid pressure will build within chamber 236 up to the pressure of the hydraulic system, which preferably ranges from about fifty (50) psi to about sixty (60) psi. Once the pressure in chamber 236 exceeds the preset pressure value, the pressure relief valve will open and cause bypass valve 125 to open. In this manner, the bypass valve 125 is operable to correct a continued low-velocity airflow condition.

In other instances, the compressed airflow discharged from the compressor 26 can encounter greatly reduced backpressure. For example, in a pneumatic conveying system, the operator may eliminate particulate matter from the line downstream of the compressor discharge. In this instance, airflow velocity through the compressor 26 will generally increase and the spring 204 will cause the sensor arm 200 to shift rearwardly, i.e., toward the impeller, so that the valve shifts into a vane-closing condition, which causes the vanes 90 to close. Thus, the vanes 90 close so that the inlet guide vane assembly 34 provides a substantial airflow restriction to intake airflow. Consequently, airflow velocity will decrease and return to the desired airflow velocity.

Turning to FIGS. 17 and 18, a second preferred embodiment of an alternative compressor package 300 is depicted. For the sake of brevity, the remaining description will focus primarily on the differences of this embodiment relative to the embodiment described above. The primary difference is the use an airflow sensor with a damping diaphragm. The alternative compressor package 300 includes a compressor 302, an inlet guide vane assembly 304, and an alternative sensor assembly 306. The sensor assembly 306 broadly includes an arm 308, plate 310, a spring 312, an adjuster 314, and a diaphragm 316. The diaphragm 316 and spring 312 are both attached to the arm 308 at the same location between ends of the arm 308. The diaphragm 316 also fluidly communicates with the compressor volute so as to sense a compressor discharge pressure. Consequently, the illustrated sensor assembly 306 controls the inlet guide vanes in response to airflow velocity and compressor discharge pressure.

Turning to FIG. 18, without the diaphragm 316, the compressor package 300 has an operational characteristic identified by line 318, i.e., the compressor package 300 would provide a substantially constant airflow velocity over a range of compressor pressures. With the diaphragm 316, performance of the compressor package 300 can be adjusted to provide alternative operational characteristics identified by lines 320,322.

The adjustable compressor performance provided by diaphragm 316 has been found to be particularly desirable in a pneumatic conveying application. For example, when little or no particulate media is being conveyed in the system, the compressor will produce a relatively low discharge pressure with relatively high velocity. The diaphragm 316 is configured to push the sensor arm rearwardly to thereby encourage opening of the inlet guide vanes in a low-pressure condition (see FIG. 17). For example, when a heavy media, such as flour, is initially introduced into the conveying system, the flour can readily cause clogging of the media line. Thus, the illustrated diaphragm 316 is preferably connected to the sensor to further increase airflow velocity when the media line has little or no media in it, and the illustrated diaphragm 316 provides a compressor operational characteristic identified by line 322 (see FIG. 18). In this manner, the media line is ready to receive a subsequent slug of media without becoming clogged.

For other purposes, the diaphragm 316 can be configured so as to push the sensor arm forwardly to encourage at least partial closure of the inlet guide vanes in response to low compressor discharge pressure to thereby reduce airflow velocity. By reducing airflow velocity, the power requirements of the compressor are reduced, thus saving energy. Such a diaphragm configuration provides a compressor operational characteristic identified by line 320 (see FIG. 18). For some types of media, such as plastic granules, it has been found that media can be introduced into the conveying system at relatively low-velocity airflow without clogging the media line.

### Additional Embodiments

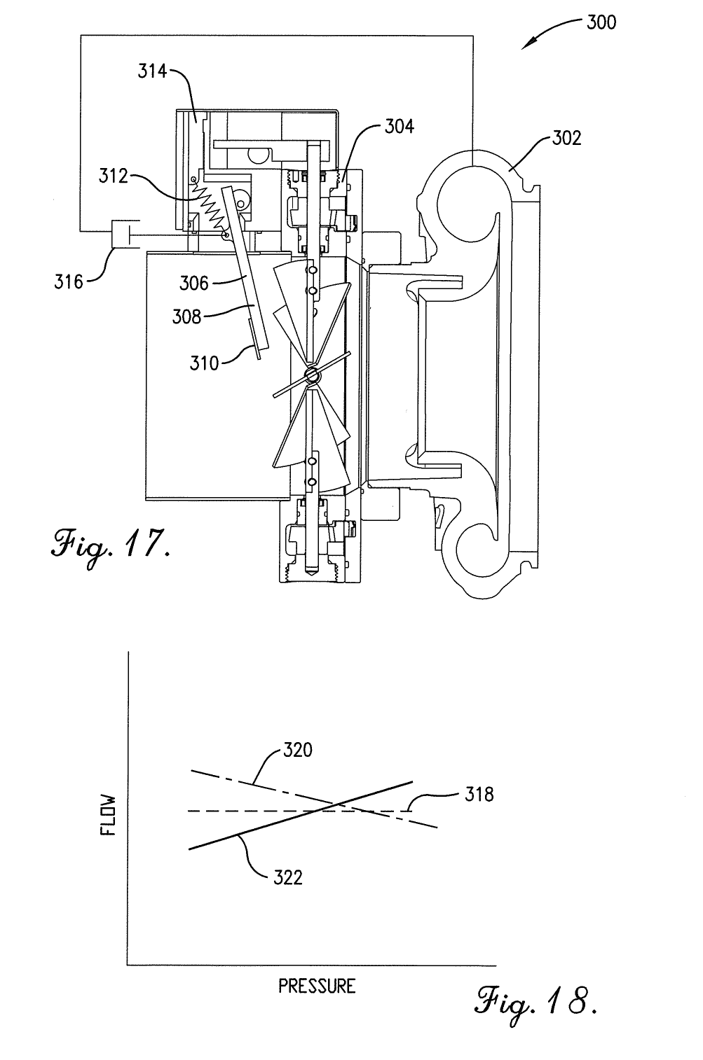

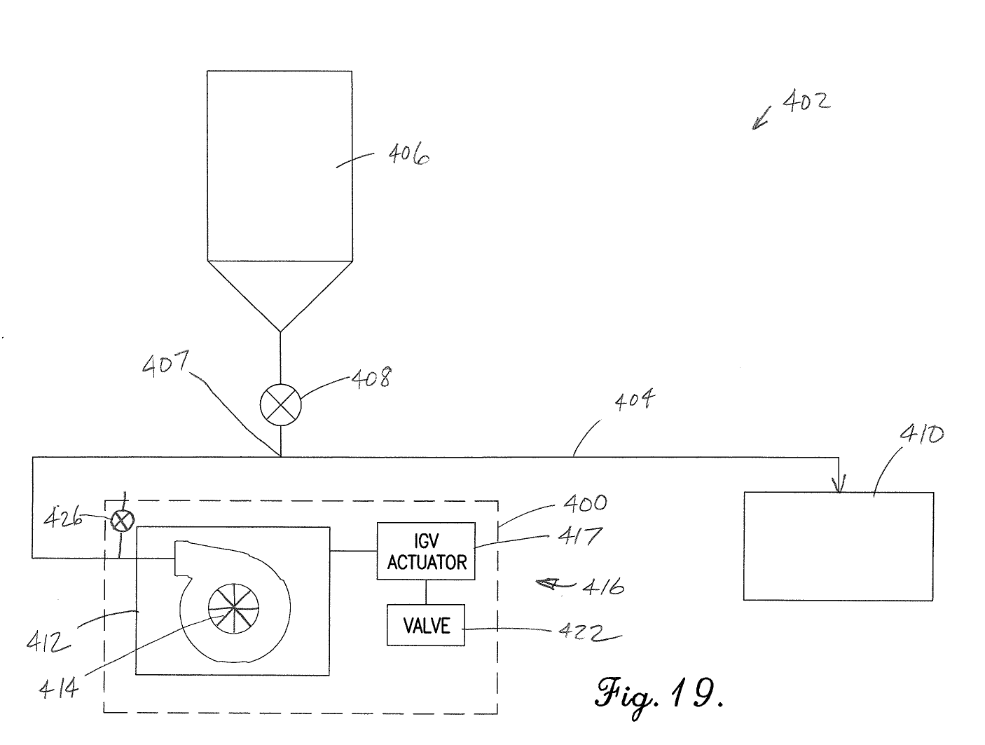

Turning to FIGS. 19-35, an alternative compressor package 400 is depicted as part of a pneumatic conveying system 402. For brevity, the description of this system 402 will focus primarily on the differences of this embodiment relative to the previously described embodiment.

Turning to FIG. 19, in addition to the compressor package 400, the illustrated pneumatic conveying system 402 includes a main flow line 404, media storage tank 406, media valve 408, and downstream media equipment 410, including a separator (not shown). The conveying system 402 is preferably operable to transport various types of particulate media, such as plastics, flours, etc. The tank 406 stores the media and permits media to be discharged into the flow line 404 at media pickup location 407 by opening the media valve 408. However, as will be appreciated, the system 402 could have various alternative configurations to suitably convey media for different conveying applications without departing from the scope of the present invention.

Turning to FIGS. 19-22, the illustrated compressor package 400 is preferably configured for use with the system 402. As will be discussed in greater detail, the compressor package 400 preferably provides a substantially constant airflow velocity at the media pickup location 407, and this velocity is referred to as the pickup velocity. Generally, a desired pickup velocity is selected to be greater than the saltation velocity (i.e., the velocity at which airflow becomes insufficient to maintain solids in suspension and the solids begin to settle in the bottom of the conveying line) for a given media. For example, the desired pickup velocity for flour preferably ranges from about three thousand (3000) feet per minute to about three thousand five hundred (3500) feet per minute.

Furthermore, the compressor package 400 is preferably operable to overcome media blockage that develops in the flow line 404 downstream of the compressor. As will be explained in greater detail, the compressor package 400 is preferably designed to maintain airflow and pressure in reserve. More particularly, the compressor package 400 includes an inlet guide vane assembly that is preferably operated in a partly closed condition during normal conveying operation so that the compressor can provide additional flow and pressure when necessary, e.g., to overcome downstream blockage.

As with the previously disclosed embodiments, the compressor package 400 is suitable to be retrofitted into a pneumatic conveying system (e.g., to replace a positive-displacement compressor). However, the compressor package 400 is operable to provide compressed air for other applications without departing from the scope of the present invention. The compressor package 400 broadly includes, among other things, a centrifugal compressor 412, an inlet guide vane assembly 414, and an alternative guide vane controller 416.

The illustrated compressor 412 is conventional and includes a compressor housing and an impeller. The compressor 412 preferably operates at an impeller rotational speed of 41,200 revolutions per minute and provides a corresponding flow rate of 625 cubic feet per minute.

The controller 416 is operable to position vanes of the guide vane assembly so that the compressor 412 provides a compressed airflow with a substantially constant velocity. The controller 416 preferably includes a hydraulic actuator 417 with a housing assembly 418 and a hydraulically-driven actuator piston 420, a valve assembly 422, a sensor assembly 424, and a bypass valve 426.

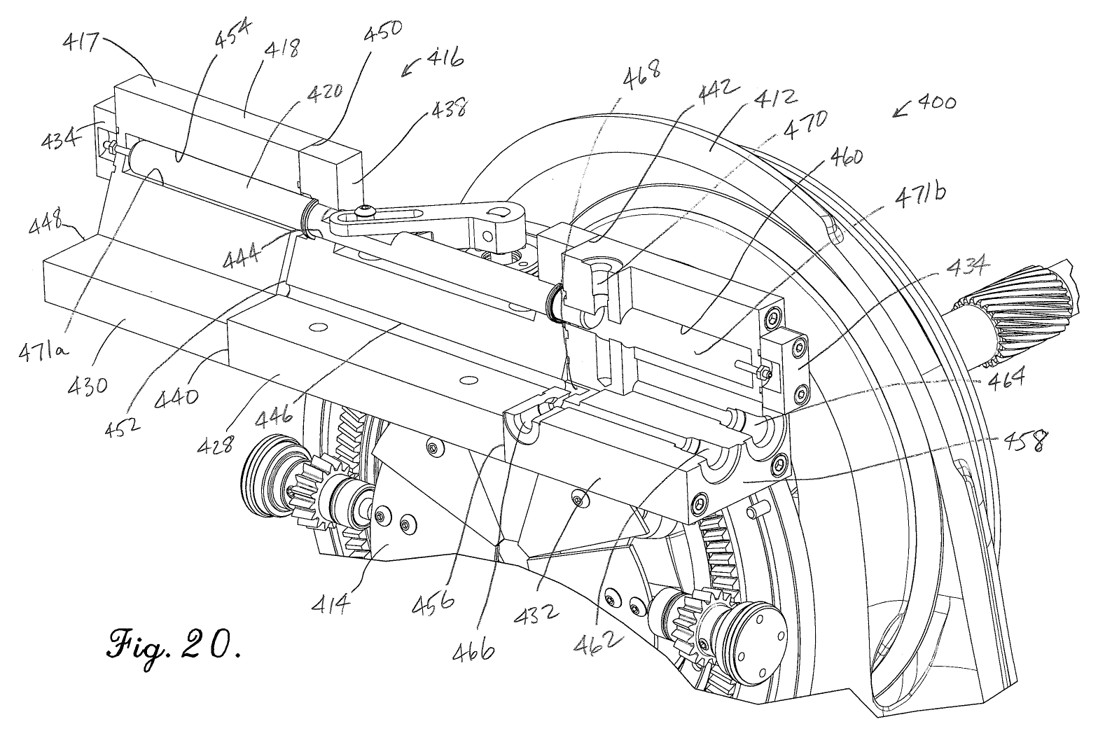

Turning to FIG. 20, the housing assembly 418 preferably includes a central housing 428, end manifolds 430,432, and end caps 434. The central housing 428 includes a generally rectangular cuboid body that presents an open rear slot 438 spaced between ends of the housing 428, end faces 440,442, a transverse piston bore 444, and a central fluid bore 446.

The end manifold 430 comprises a generally rectangular cuboid body and presents end faces 448,450. The end face 450 includes a slot 452 spaced from the outer margin of the end face 450. A piston end bore 454 extends from the slot 452 toward the end face 448.

The end manifold 430 is removably attached to the central housing 428 with fasteners (not shown) so that the end face 450 engages the end face 440 of the central housing 428, with the piston bores 444,454 being aligned with one another. Also, the recess presented by the slot 452 preferably fluidly communicates with the fluid bore 446.

The end manifold 432 also comprises a generally rectangular cuboid body and presents end faces 456,458. A piston end bore 460 extends from end face 456 toward the end face 458. The end manifold 432 also presents transversely extending bores 462,464 extending from the end face 458 toward the end face 456. A fore-and-aft bore 466 extends from the front face of the end manifold 432 to a port 468 so that the port 468 and bore 462 fluidly communicate with one another. An upright bore 470 extends from the top face of the end manifold 432 to bore 464 and fluidly communicates with bore 464. Once the bores 466,470 are machined, the open ends of bores 466,470 are closed with plugs (not shown) to prevent fluid leakage from the bores.

The end manifold 432 is removably attached to the central housing 428 with fasteners (not shown) so that the end face 456 engages the end face 442 of the central housing 428 and the piston bores 444,460 are aligned with one another. Also, the fluid bore 446 fluidly communicates with port 468. Thus, the piston 420 is slidably received by bores 444,454,460 so that the housing assembly 418 and piston 420 cooperatively form an opening chamber 471a and a closing chamber 471b. Similar to the previous embodiments, the piston 420 is attached to the inlet guide vane assembly 414 with a swing arm. While the illustrated actuator configuration is preferred, the principles of the present invention are applicable where an alternative actuator is used to move the inlet guide vanes. As will be discussed, the housing assembly 418 and the hydraulic assembly (not shown) are fluidly connected to one another by the valve assembly 422 so that pressurized hydraulic fluid can be supplied to the actuator 417 and returned from the actuator 417.

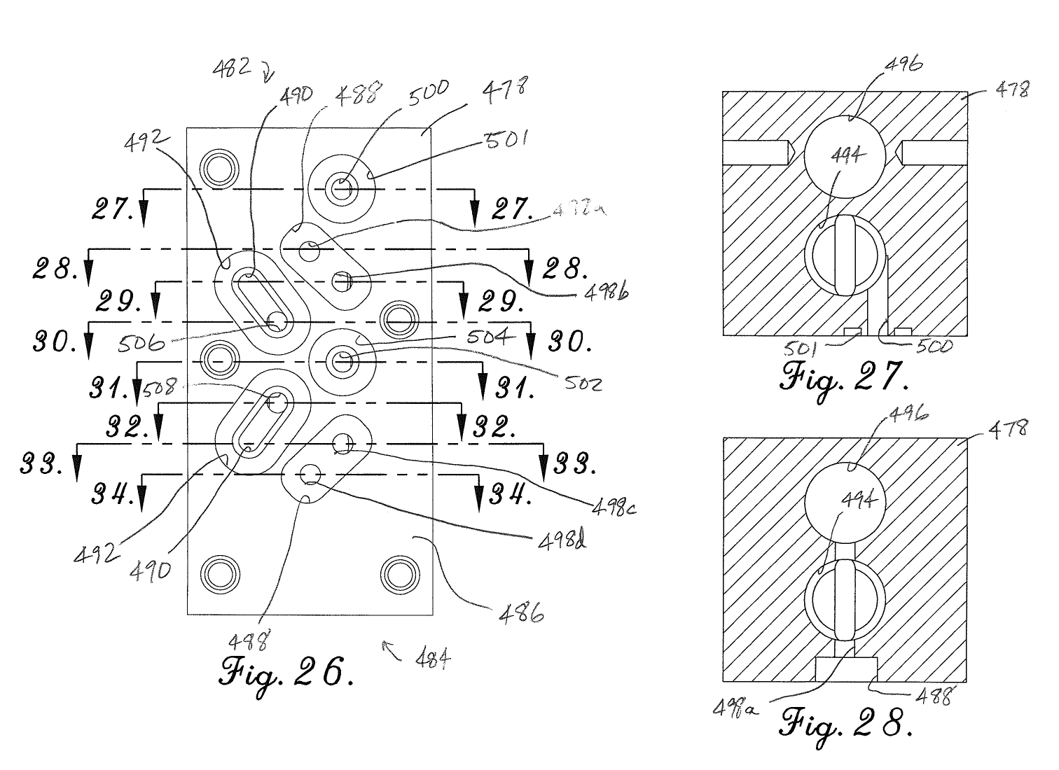

Turning to FIGS. 21-34, the valve assembly 422 is operable to control hydraulic fluid flow to and from the actuator 417. The valve assembly 422 broadly includes a valve housing 472, a valve piston 474, and a shiftable lever 476. The valve housing 472 comprises a generally rectangular cuboid construction and includes a body 478 and a cover 480. The body 478 is preferably unitary and presents upper and lower ends 482,484 and a face 486 that extends between the ends 482,484 (see FIG. 26). The body 478 also presents slotted openings 488 and slotted openings 490 that extend along the face 486, with o-ring glands 492 that surround respective openings 490. The valve assembly 422 further includes rubber stops (not shown) that are inserted between the body 478 and cover 480 in openings 488 and o-rings (not shown) that are inserted in glands 492.

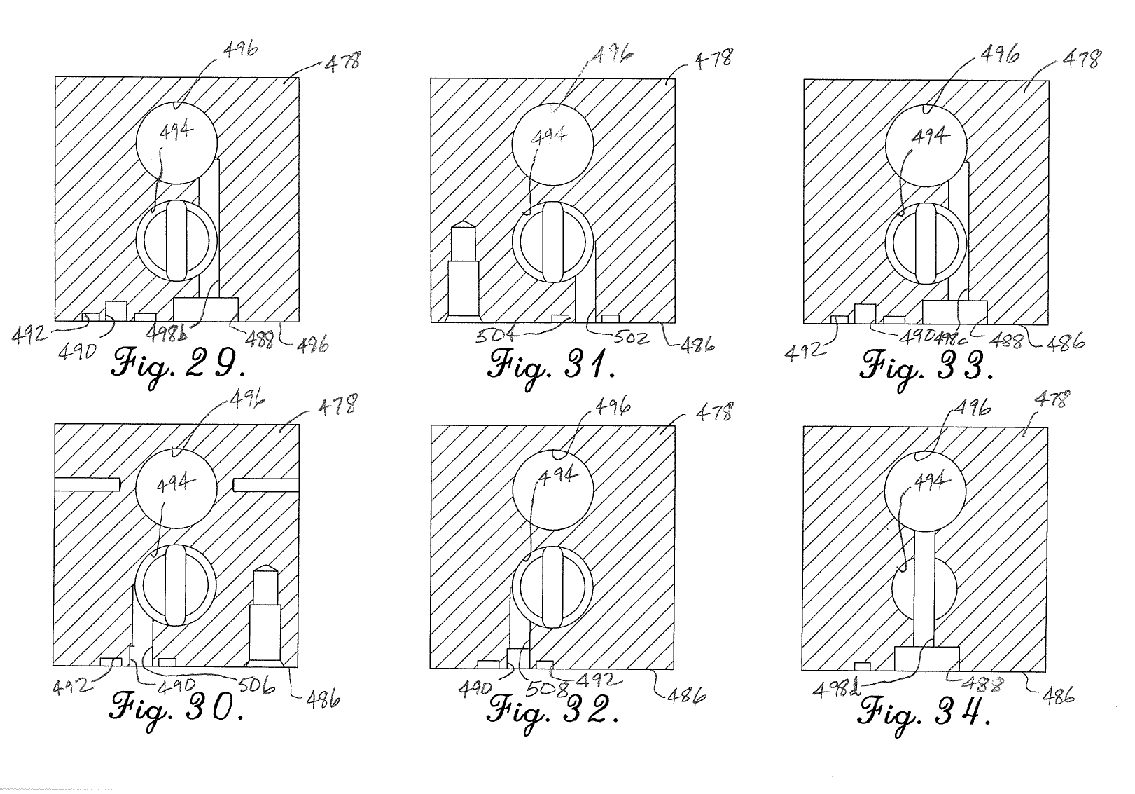

The body 478 presents a piston bore 494 that extends from the upper end 482 toward the lower end 484 and is operable to receive the piston 474. The body 478 also presents a drain chamber 496 that extends from the lower end 484 toward the upper end 482. The body 478 further presents lateral drain ports 498a,b,c,d that extend from respective slotted openings 488 through the piston bore 494 and to the drain chamber 496 (see FIGS. 26, 28, 29, 33, and 34). A lateral relief port 500 is positioned adjacent the upper end 482 with a surrounding o-ring gland 501 (see FIGS. 26 and 27). Yet further, the body 478 presents a lateral supply port 502 that extends from the face 486 to the piston bore 494 and is surrounded by an o-ring gland 504 (see FIGS. 26 and 31). The body 478 also presents upper and lower lateral return ports 506,508 that extend from the face 489 to the piston bore 494 (see FIGS. 26, 30, and 32). The valve assembly 422 also includes o-rings (not shown) that are inserted in glands 501 and 504.

The cover 480 is preferably unitary and presents opposite inner and outer faces. The cover 480 presents several lateral ports including a relief port 510, a supply port 512, and upper and lower return ports 514,516 (see FIG. 21). The cover 480 is removably attached to the body 478 with multiple threaded fasteners 518. When attached, the cover 480 is aligned with the body 478 so that the relief ports 500,510 are in fluid communication, the supply ports 502,512 are in fluid communication, the upper return ports 506,514 are in fluid communication, and the lower return ports 508,516 are in fluid communication.

The cover 480 is preferably constructed so that conventional hydraulic lines (not shown) can be removably attached to each of the respective ports. In particular, the supply port 512 is preferably fluidly connected to the hydraulic system (not shown), which supplies pressurized hydraulic fluid to the controller 416. The upper return port 506 is preferably fluidly connected to the opening chamber 471 a via the port 514. The lower return port 508 is preferably fluidly connected to the closing chamber 471b via the port 516.

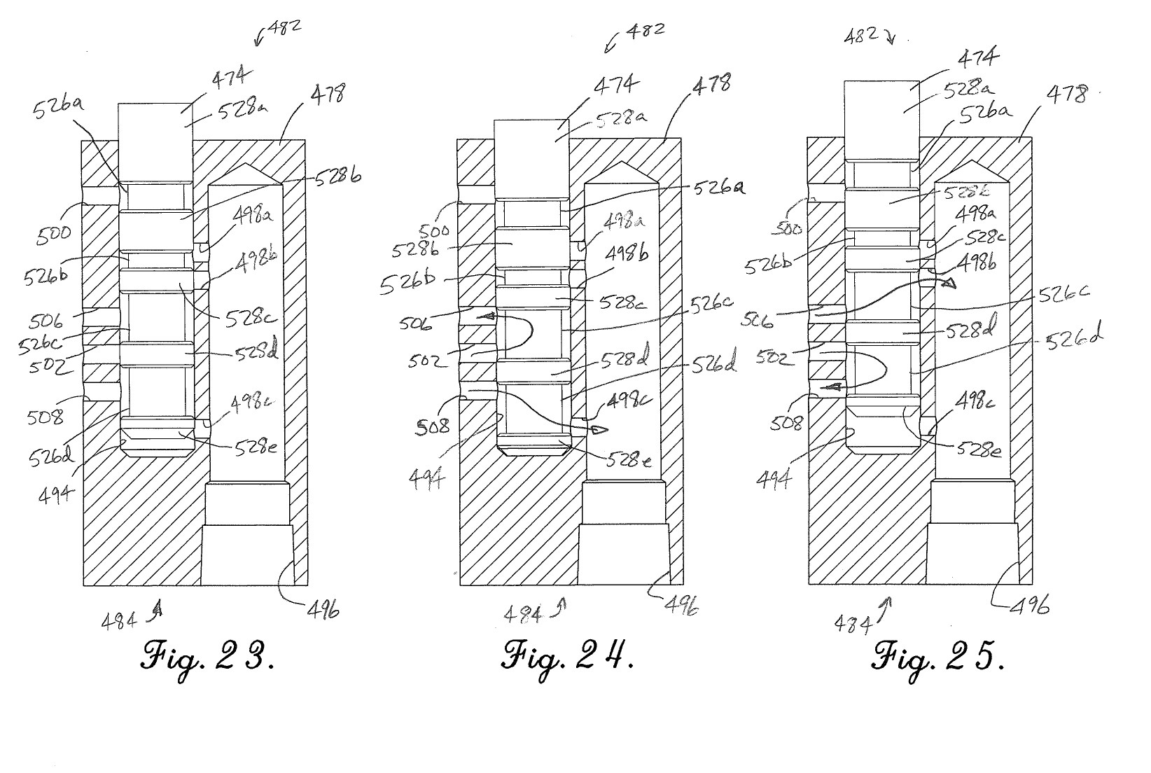

Turning to FIGS. 21-25, the valve piston 474 preferably includes a piston body 520, a connector 522, and straps 524. The piston body 520 presents opposite upper and lower ends and presents a generally outer cylindrical surface that extends between the ends. The piston body 520 also preferably presents endless annular grooves 526a,b,c,d spaced between the ends (see FIGS. 23-25). Uppermost groove 526a permits removal of fluid from the piston bore 494 through relief ports 500,510. Drain groove 526b permits drainage of fluid from the piston bore 494 through one of the drain ports 498a,b. Diversion grooves 526c,d each permit diversion of fluid from the supply port 502 to either a corresponding drain port 498b,c or to a corresponding return port 506,508. Adjacent the grooves 526 are piston sections 528a,b,c,d,e used to restrict fluid flow.

The valve piston 474 is slidably received in the piston bore 494 and is operable to slide along the piston axis. The piston 474 and housing 472 preferably do not have an o-ring seal therebetween so that friction is minimized as the piston 474 slides relative to the housing 472.

The piston 474 is slidable between opening, closing, and neutral positions to selectively provide pressurized hydraulic flow to the actuator. In the neutral position, the piston section 528d covers the supply port 512 and restricts fluid flow through the supply port 512 into the piston bore 494. Similarly, the sections 528c,e cover drain ports 498b,c and restrict flow through the return ports 506,508. Thus, in the neutral position, fluid flow into and out of the chambers 471a,b is preferably restricted so that the actuator 417 is restricted from moving the guide vanes.

In the opening position, the piston section 528d is located between the supply and lower return ports 502,508 to restrict flow therebetween. Thus, fluid is permitted to flow from the lower return port 508 to the drain chamber 496 by passing through the lower diversion groove 526d. Also, fluid is permitted to flow from the supply port 502 to the upper return port 506 by passing through the upper diversion groove 526c.

The opening position allows fluid flow to cause the actuator to urge the vane assembly 414 open. In particular, the upper return port 506 fluidly communicates with the opening chamber 471 a so that pressurized hydraulic fluid is pumped from the hydraulic system into the opening chamber 471a. At the same time, the lower return port 508 fluidly communicates with the closing chamber 471b so that hydraulic fluid is drained from the closing chamber 471b and returned to the hydraulic system. Consequently, this movement of hydraulic fluid urges the actuator piston 420 into the opening condition (not shown) so that the vanes are shifted open.

In the closing position, the piston section 528d is located between the supply and upper return ports 502,506 to restrict flow therebetween. Thus, fluid is permitted to flow from the upper return port 506 to the drain chamber 496 by passing through the upper diversion groove 526c. Also, fluid is permitted to flow from the supply port 502 to the lower return port 508 by passing through the lower diversion groove 526d.

The closing position allows fluid flow to cause the actuator to urge the vane assembly 414 closed. In particular, the lower return port 508 fluidly communicates with the closing chamber 471b so that pressurized hydraulic fluid is pumped from the hydraulic system into the closing chamber 471b. At the same time, the upper return port 506 fluidly communicates with the opening chamber 471a so that hydraulic fluid is drained from the opening chamber 471a and returned to the hydraulic system. Consequently, this movement of hydraulic fluid urges the actuator piston 420 into the closing condition (see FIG. 20) so that the vanes are shifted closed.

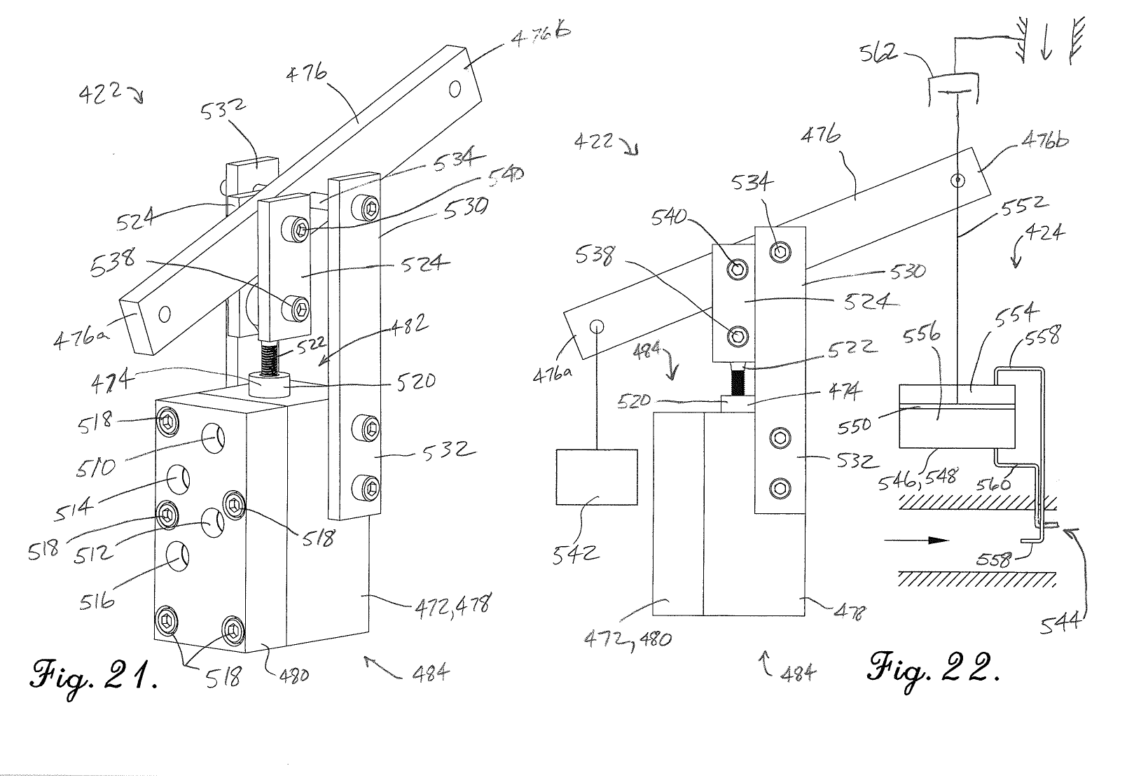

Turning to FIGS. 21 and 22, the lever 476 is preferably unitary and presents opposite lever ends 476a,b. The lever 476 is mounted to the housing 472 with a lever support 530, which includes upright braces 532 and a fastener 534 that extends laterally to interconnect upper ends of the braces 532. The lever 476 presents a hole spaced between the ends that rotatably receives the lateral fastener 534. Thus, the supported lever 476 is operable to pivot about the axis of the fastener 534.

The threaded connector 522 is attached to the piston body 520 at the upper end thereof. The illustrated connector 522 preferably comprises an eyebolt that presents an eye. The piston 474 and lever 476 are interconnected by straps 524. Lower ends of straps 524 are attached to the eyebolt with a fastener 538 that is secured through the lower ends of straps 524 and the eye of connector 522. Upper ends of straps 524 are attached to the lever 476 with a fastener 540 that is secured through the upper ends of straps 524 and the lever 476. Thus, up and down movement of the piston 474 causes corresponding up and down movement of the lever end 476a.

In the illustrated embodiment, a weight 542 is preferably attached to the lever end 476a to urge the piston 474 into the piston bore 494 and toward the opening position. However, the principles of the invention are applicable where the valve assembly 422 has an alternative counterbalance mechanism so that the valve assembly 422 is operable to regulate airflow velocity. For example, the lever 476 could be alternatively biased to urge the piston 474 into the opening position, e.g., where a spring is attached to the lever end 476a (or at another location along lever 476) to urge the lever end 476a downwardly.

Turning to FIG. 22, the sensor assembly 424 is preferably configured to sense pressures within the compressor discharge (or volute) and act on the lever 476 of the valve assembly 422 in response to the sensed pressures, although pressure conditions could alternatively be sensed elsewhere in the line (e.g., within the compressor inlet or downstream from the compressor discharge). The sensor assembly 424 preferably includes a conventional pitot tube 544 and a diaphragm 546. The diaphragm 546 is also conventional and includes a housing 548 and a shiftable diaphragm element 550. The diaphragm element 550 acts as a piston and is attached to a rod 552, which is attached to end 476b. The diaphragm element 550 and housing 548 cooperatively define chambers 554,556 on opposite sides of the diaphragm element 550.

The pitot tube 544 preferably includes a high pressure tube 558 with an end that faces into the airflow and is preferably used to measure a high pressure (preferably total pressure) within the compressor discharge. The pitot tube 544 also preferably includes a low pressure tube 560 with an end that faces away from the airflow and is used to measure a low pressure in the compressor discharge. The low pressure tube 560 preferably faces away from the airflow so that the sensed pressure is less than static pressure within the discharge. In this manner, the illustrated pitot tube 544 maximizes the difference between high and low pressures. However, the principles of the present invention are applicable where an alternative pitot tube is used, e.g., where the low pressure tube is designed to sense static pressure. Again, it is also within the scope of the present invention where the sensor assembly 424 is used to sense airflow pressures at another location along the system (e.g., where pressures are sensed at the compressor inlet). The tubes 558,560 are connected to the diaphragm 546 so that the high pressure tube 558 is in fluid communication with chamber 554 and the low pressure tube 560 is in fluid communication with chamber 556. Thus, the illustrated diaphragm 546 is operable to sense a pressure differential, which one of ordinary skill in the art will appreciate is proportional to airflow velocity at the location where pressures are measured.

The compressor 412, inlet guide vane assembly 414, and controller 416 preferably operate so that the compressor 412 provides airflow at a gauge pressure that ranges from about five (5) pounds per square inch (psig) to about eleven (11) psig. More preferably, under normal operating condition, the compressor 412 provides airflow at a pressure of about 8.8 psig. Also, under normal operating condition, each vane of the inlet guide vane assembly 414 is preferably positioned so that the chord of the vane forms a preswirl angle that ranges from about forty (40) degrees to about fifty (50) degrees relative to the passage axis and, more preferably, is about forty-five (45) degrees.

The controller 416 is operable to increase the throttling of airflow under certain conditions. For instance, when the flow of media into flow line 404 is suddenly decreased or stopped, the controller 416 is operable to sense a corresponding increase in airflow velocity and close the vane assembly 414. As the sensor assembly 424 senses a relatively large airflow velocity, the diaphragm 546 is urged downwardly and the piston 474 is urged upwardly toward the closing position. Consequently, this shifting of the valve causes the actuator 417 to be shifted toward the closing condition, which shifts the vanes closed to subsequently reduce airflow velocity. For example, the illustrated vane assembly 414 can be shifted to a maximum preswirl condition where the vane is at a preswirl angle of about seventy-nine (79) degrees relative to the passage axis. In this condition, the illustrated compressor provides airflow at a pressure of about 5.3 psig.

Similarly, the controller 416 is also operable to decrease the throttling of airflow under certain conditions. For example, as discussed above, the compressor package 400 is preferably operable to overcome media blockage that develops in the flow line 404 downstream of the compressor. The controller 416 is operable with the inlet guide vane assembly 414 to maintain airflow and pressure in reserve. The inlet guide vane assembly 414 is preferably operated in a partly closed condition during normal conveying operation so that the compressor can provide additional flow and pressure when necessary, e.g., to overcome downstream blockage.

As the sensor assembly 424 senses a relatively small airflow velocity, the diaphragm 546 moves upwardly so that the piston 474 moves downwardly toward the opening position. Consequently, this shifting of the valve causes the actuator 417 to be shifted toward the opening condition, which shifts the vanes open to increase airflow velocity.

For example, the illustrated vane assembly 414 can be shifted to an open condition where the vane is substantially aligned with the passage axis. In the open condition, the illustrated compressor provides airflow at a pressure of about ten (10) psig. In one counterswirl condition, the vanes are positioned with a counterswirl angle of about twenty (20) degrees from the passage axis. In this counterswirl condition, the compressor provides airflow at a pressure of about 10.5 psig.

The sensor assembly 424 also preferably includes another diaphragm 562, similar to diaphragm 316, that fluidly communicates with the compressor volute to sense compressor static discharge pressure. With diaphragm 562, the performance of compressor package 400 can be adjusted to provide alternative operational characteristics. As with diaphragm 316, when little or no particulate media is being conveyed in the system 402, the compressor 412 will produce airflow with relatively low discharge pressure and relatively high velocity. The diaphragm 562 is configured to shift the lever 476 upwardly to encourage opening of the inlet guide vane assembly 414 in a low-pressure condition. Thus, the diaphragm 562 is preferably connected to the lever 476 to further increase airflow velocity when the main flow line 404 has little or no media in it. Thus, the main flow line 404 is prepared to receive a slug of media without becoming clogged. However, the principles of the present invention are applicable where the sensor assembly 424 is devoid of diaphragm 562.

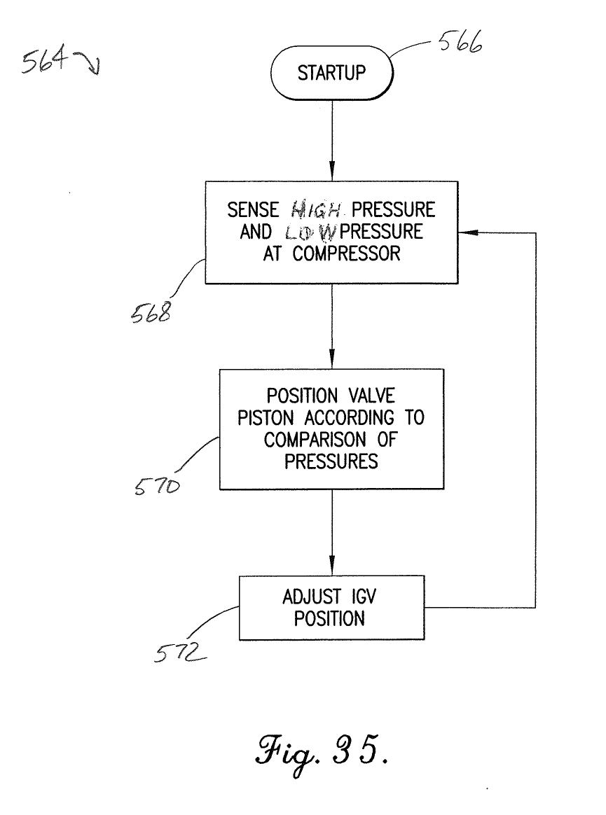

Turning to FIG. 35, in a method 564 of using the compressor package 400, the compressor package 400 is started at step 566. High and low pressures are sensed by the pitot tube 544 of the sensor assembly at step 568. In response to the sensed pressures, the diaphragm 546 shifts the valve piston 474 at step 570 according to the sensed pressures. The actuator is then controlled at step 572 in response to valve movement to adjust the inlet guide vane assembly 414.

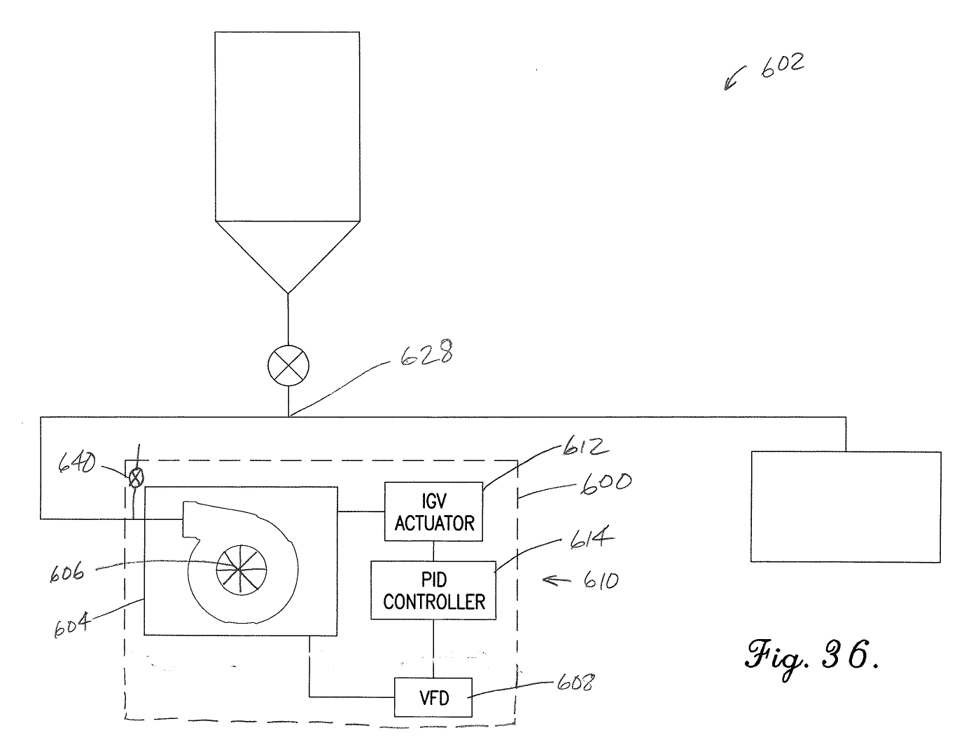

Turning to FIGS. 36-38, an alternative compressor package 600 is depicted as part of pneumatic conveying system 602. For brevity, the description of this system 602 will focus primarily on the differences of this embodiment relative to the previous system 402.

The illustrated compressor package 600 is preferably configured for use with the system 602. As with the previously disclosed embodiments, the compressor package 600 is suitable for use as a retrofit into a pneumatic conveying system in place of a positive-displacement compressor. However, the compressor package 600 is operable to provide compressed air for other applications without departing from the scope of the present invention. The compressor package 600 broadly includes, among other things, a centrifugal compressor 604, an inlet guide vane assembly 606, a variable frequency drive 608, and an alternative guide vane controller 610.

The variable frequency drive (VFD) 608 is conventional and is operable to drive an A/C motor (not shown) of the compressor package 600. The motor is drivingly connected to the compressor 604. The drive 608 is operable to change the rotational speed of the motor and thereby change the rotational speed of the compressor impeller. Rotational speed of the compressor impeller is preferably sensed using a Hall Effect sensor (not shown).

The illustrated compressor package 600 preferably includes both the inlet guide vane assembly 606 and the drive 608 to control compressor airflow. However, it is also within the ambit of the present invention where the package 600 does not have a variable frequency drive such that airflow control is provided by the inlet guide vane assembly 606. Similarly, the compressor package 600 could be alternatively constructed without the inlet guide vane assembly 606 so that the drive 608 controls compressor airflow.

As with the previous embodiments, the controller 610 is operable to position vanes of the guide vane assembly 606 so that the compressor 604 provides a compressed airflow with a substantially constant velocity. Importantly, the illustrated controller 610 is also preferably configured as part of the package 600 so that the package 600 can be used as a convenient retrofit to an existing pneumatic system compressor. However, instead of the mechanical controllers disclosed in the previous compressor package embodiments, the controller 610 provides electronic control of the compressor package. The controller 610 preferably includes, among other things, a guide vane actuator 612 and a programmable logic controller 614.

The actuator 612 is preferably a servo motor, which has a closed loop position control. The actuator 612 is drivingly attached to one of the shafts connected to a corresponding guide vane. Thus, movement of the servo causes corresponding movement of the guide vanes. The actuator 612 is operably coupled to the controller 614 so that the controller 614 controls and reads servo position.

The controller 610 also includes multiple sensors. For instance, the controller 610 includes a hot wire anemometer (not shown), an oil pressure sensor (not shown), a static pressure sensor (not shown), and an ambient temperature sensor (not shown). The anemometer is preferably mounted in the compressor discharge to sense the velocity of compressor discharge airflow. The static pressure sensor is preferably installed in the compressor discharge. However, it is also within the ambit of the present invention where the pressure sensor and/or anemometer are mounted to sense the airflow at another location within the system, such as at the compressor inlet. The oil pressure sensor is installed to sense compressor hydraulic pressure. The ambient temperature sensor is mounted in any suitable location on or adjacent the compressor package to reliably measure ambient temperature.

The programmable logic controller 614 is preferably programmable as a PID controller. However, the principles of the present invention are equally applicable where other types of controller algorithms are employed to operate the compressor package 600.

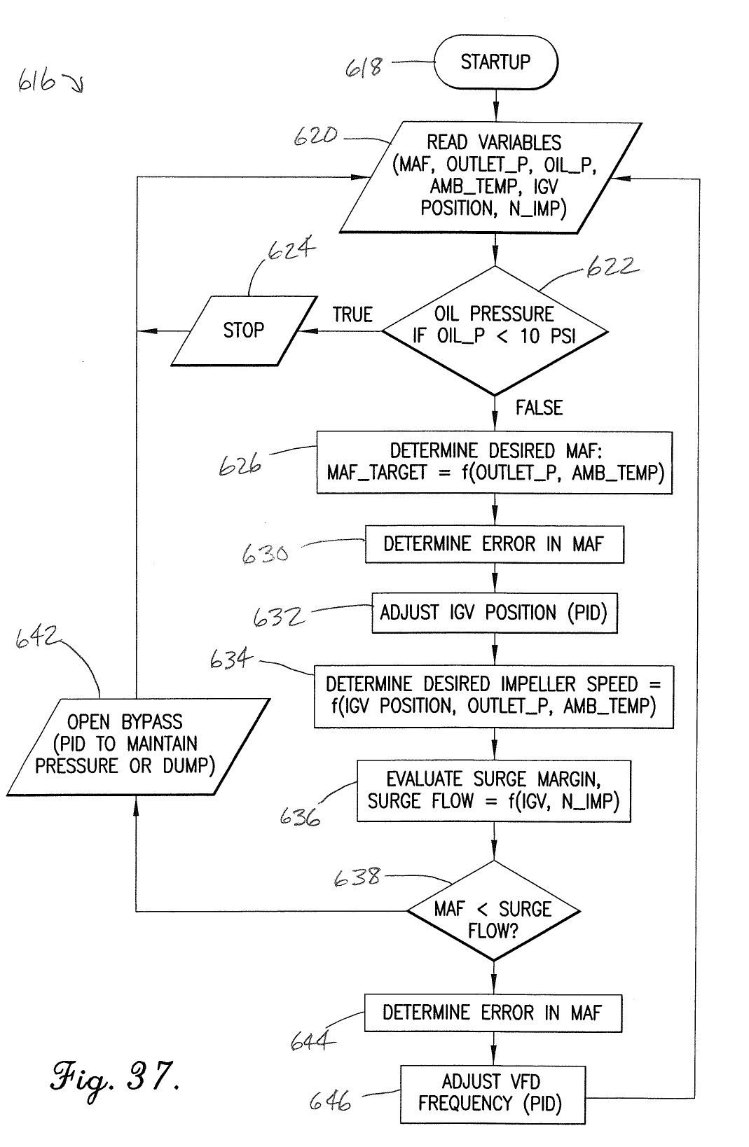

Turning to FIG. 37, in a method 616 of using the compressor package 600, the compressor package 600 is started at step 618. At step 620, the controller 614 is then used to sense mass air flow (MAF), the static compressor discharge pressure (OUTLET_P), the compressor oil pressure (OIL_P), ambient temperature (AMB_TEMP), position of the inlet guide vanes (IGV POSITION), and impeller speed (N_IMP). The controller 614 then determines, at step 622, if OIL_P is less than ten (10) psi. If so, the controller stops the compressor package at step 624. If not, the controller 614 proceeds to step 626 to calculate a desired mass air flow rate of the compressor (MAF_TARGET) as a function of OUTLET_P and AMB_TEMP. The MAF TARGET value is also calculated as a function of desired air flow pickup velocity adjacent a media pickup location 628 (see FIG. 36). In calculating the MAF_TARGET value, the pressure at the location 628 is estimated from the OUTLET_P value using conventional pipe flow loss calculations. Also, the temperature adjacent the location 628 is estimated by measuring and recording ambient temperature over time and by predicting air and media temperatures. For the purpose of performing calculations as part of the process of controlling the system 602, the desired pickup velocity and other flow conditions are preferably determined for a location immediately adjacent and downstream of the media pickup location 628 (e.g., preferably about one foot downstream of the location 628). Compressor discharge temperature is calculated as a function of pressure ratio, time, mass of the main line piping system, and cooling through heat transfer of the piping system. Temperature of media is preferably determined as a function of time the media is held in the storage tank, ambient temperature, and media conveying rate.

It is also within the ambit of the present invention where the media pickup temperature is alternatively determined. For instance, the temperature could be measured directly at a location slightly downstream of the media pickup location 628. Also, the temperature could be calculated by using a measured temperature of the media prior to media introduction in the main flow line and a measured temperature of airflow prior to the media pickup location 628.

At step 630, the controller 614 determines the error in MAF as the difference between MAF_TARGET and MAF. This error value is used in step 632 to adjust the inlet guide vane position. At step 634, a desired rotational speed of the impeller is determined as a function of IGV POSITION, OUTLET_P, and AMB_TEMP. At step 636, the value at which the compressor 604 will enter a surge condition (i.e., the surge flow) is calculated as a function of IGV POSITION, and N_IMP. The controller 614 then determines, at step 638, if MAF is less than the calculated surge flow. If so, a bypass valve 640 (see FIG. 36) is opened by the controller 614 at step 642 to maintain static pressure in the flow line below a predetermined discharge pressure. If not, the controller 614 proceeds to step 644 where the error in mass air flow is again determined. At step 646, the calculated mass air flow error is used to adjust the drive frequency provided by the variable frequency drive (VFD), preferably using a PID control algorithm.

The illustrated method 616 has been found to be particularly effective for controlling the centrifugal compressor package to provide substantially constant airflow velocity. The controller 614 preferably controls the guide vane assembly 606 and variable frequency drive 608 to provide responsive control of airflow velocity while permitting the compressor package to operate at optimum efficiency. The guide vane assembly 606 has been found to provide more responsive change in airflow compared to the drive 608. Thus, the control algorithm preferably uses a higher gain in connection with the guide vanes compared to the drive 608.

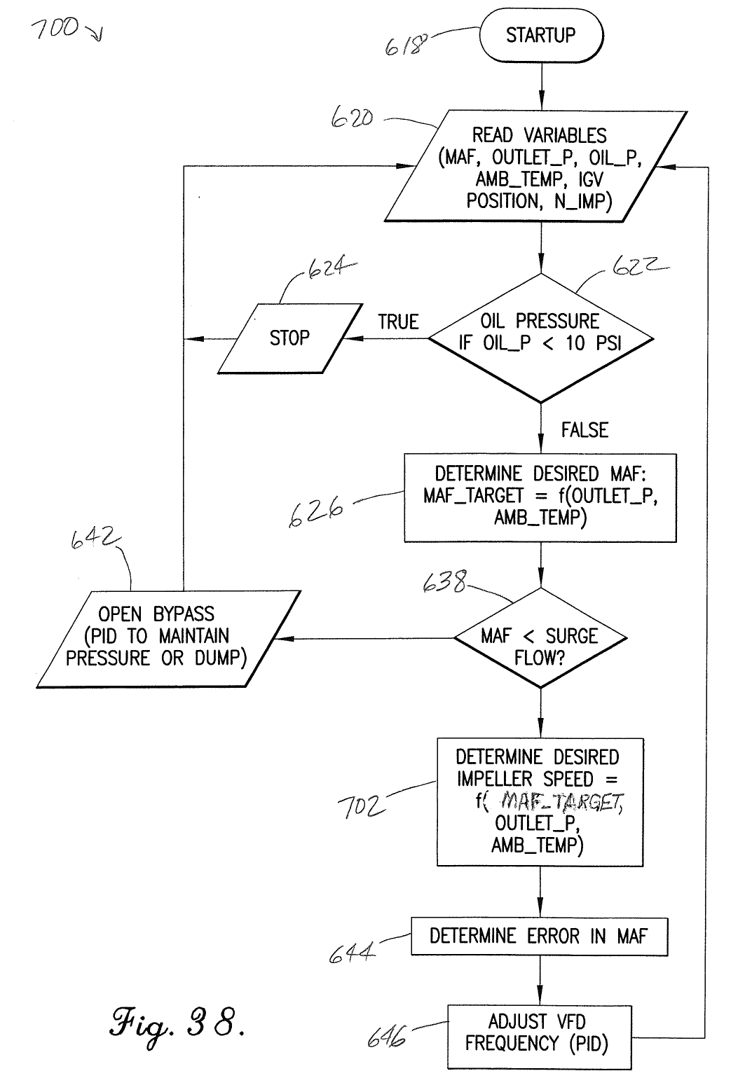

Again, the principles of the present invention are applicable where an alternative control algorithm is employed to provide suitable control over system operation. For instance, the controller 614 could be operated using an alternative process where the system 602 does not include an inlet guide vane assembly (or where the inlet guide vane assembly is held in an open condition). It is also within the ambit of the present invention where the controller 614 is operated using a process where the system 602 does not include a variable frequency drive (or where the variable frequency drive is not utilized to provide variable impeller speeds during system operation). Turning to FIG. 38, one alternative method 700 includes steps 618,620,622,624,626,638,642,644,646. The method also includes step 702, where a desired rotational speed of the impeller is determined as a function of MAF_TARGET, OUTLET_P, and AMB_TEMP. It is particularly noted that steps 630,632,636 (as disclosed in the method depicted in FIG. 37) are not included in method 700. The illustrated method 700 is particularly effective where the compressor package includes a variable frequency drive and a motor with sufficient power to provide adequate variable speed response to control the system.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A method of maintaining a desired gas flow in a pneumatic conveying system, said method comprising the steps of:
(a) driving a centrifugal compressor to direct compressed gas flow into the system;
(b) determining if a flow irregularity has occurred, with the flow irregularity determined when a sensed gas flow characteristic is found to be different from a desired value of the gas flow characteristic; and
(c) upon such an occurrence, reducing the irregularity by adjusting compressor operation to thereby change the compressed gas flow.

2. The method as claimed in claim 1,
step (c) including the step of changing rotational speed of the compressor.

3. The method as claimed in claim 2,
step (c) including the step of adjusting a gas flow valve to change gas flow through the compressor.

4. The method as claimed in claim 1,
step (c) including the step of adjusting a gas flow valve to change gas flow through the compressor.

5. The method as claimed in claim 1,
step (b) including the step of determining if a flow variable error associated with an error in gas flow velocity has occurred, with the flow variable error determined as the difference between a desired value of the determined variable and an actual value of the determined variable.

6. The method as claimed in claim 5;
(d) sensing gas flow velocity; and
(e) comparing the sensed gas flow velocity and a desired gas flow velocity.

7. The method as claimed in claim 5; and
(d) sensing a gas flow property selected from the group consisting of temperature, pressure, velocity, mass flow rate, and combinations thereof,
step (d) being performed during step (a).

8. The method as claimed in claim 7;
(e) determining the actual value of the gas flow velocity as a function of the sensed gas flow property; and
(f) comparing the actual value of the gas flow velocity and the desired value of the gas flow velocity.

9. The method as claimed in claim 5,
step (b) being performed by a processor.

10. A controller to maintain a desired gas flow in a pneumatic conveying system, said controller comprising:
a processing element being configured to:
drive a centrifugal compressor to direct compressed gas flow into the system;
determine if a flow irregularity has occurred, with the flow irregularity determined when a sensed gas flow characteristic is found to be different from a desired value of the gas flow characteristic; and
upon such occurrence, reduce the irregularity by adjusting compressor operation to thereby change the compressed gas flow.

11. The controller as claimed in claim 10,
said processing element being configured to reduce the irregularity by changing the rotational speed of the compressor.

12. The controller as claimed in claim 11,
said processing element being configured to reduce the irregularity by adjusting a gas flow valve to change gas flow through the compressor.

13. The controller as claimed in claim 10,
said processing element being configured to reduce the irregularity by adjusting a gas flow valve to change gas flow through the compressor.

14. The controller as claimed in claim 10,
said processing element being configured to determine the occurrence of the irregularity by determining if a flow variable error associated with an error in gas flow velocity has occurred, with the flow variable error determined as the difference between a desired value of the determined variable and an actual value of the determined variable.

15. The controller as claimed in claim 14,
said processing element being configured to:
sense gas flow velocity; and
compare the sensed gas flow velocity and a desired gas flow velocity.

16. The controller as claimed in claim 14,
said processing element being configured to:
sense a gas flow property selected from the group consisting of temperature, pressure, velocity, mass flow rate, and combinations thereof,
said step of sensing the gas flow property being performed during the step of driving the centrifugal compressor.

17. The controller as claimed in claim 16,
said processing element being configured to:
determine the actual value of the gas flow velocity as a function of the sensed gas flow property; and
compare the actual value of the gas flow velocity and the desired value of the gas flow velocity.

18. A compressor airflow control assembly operable to control airflow induced by a centrifugal compressor, said control assembly comprising:
an air valve assembly including a body that presents a valve passage,
said air valve assembly further including an air valve shiftably mounted in the valve passage to control airflow through the passage,
said air valve assembly operable to be mounted relative to the compressor so that the valve passage fluidly communicates with the compressor and shifting of the valve controls the compressor airflow; and
a controller assembly operable to sense an airflow pressure and responsively control shifting of the air valve,
said controller assembly including a fluidly driven actuator and a shiftable fluid valve fluidly connected to the actuator to control pressurized fluid flow from a source to the actuator,
said actuator operably coupled to the air valve so that driven movement of the actuator effects shifting of the air valve within the valve passage,
said fluid valve being shiftable so as to vary fluid flow to the actuator causing movement thereof and thereby shifting of the air valve,
said controller assembly including an airflow pressure sensor configured to sense the airflow pressure and operably coupled to the fluid valve so that sensing of the airflow pressure is operable to cause shifting of the fluid valve and a corresponding shifting of the air valve.

19. The compressor airflow control assembly as claimed in claim 18,
said airflow pressure sensor including a diaphragm with a movable diaphragm element that moves in response to sensed airflow pressure.

20. The compressor airflow control assembly as claimed in claim 19,
said diaphragm presenting diaphragm chambers on opposite sides of the diaphragm element,
said controller assembly including a pitot tube that presents pitot tube passages that cooperatively measure a pressure differential proportional to velocity of the compressor-induced airflow,
said pitot tube passages fluidly communicating with the diaphragm chambers so that the diaphragm element responds to the pressure differential.

21. The compressor airflow control assembly as claimed in claim 20,
said controller assembly further including a shiftable pressure-biasing element operable to sense pressure of the compressor-induced airflow,
said shiftable pressure-biasing element being operably coupled to the airflow sensor so that shifting of the airflow sensor is responsive to the sensed airflow pressure.

22. The compressor airflow control assembly as claimed in claim 20,
said controller assembly including a valve housing a valve element shiftably mounted in the housing,
said controller assembly including a counterbalance device that counteracts force applied to the valve element by the diaphragm element.

23. The compressor airflow control assembly as claimed in claim 22,
said controller assembly including a lever shiftably mounted to the housing, with the diaphragm element attached to the lever,
said counterbalance device comprising a weight attached to the lever.

24. The compressor airflow control assembly as claimed in claim 18,
said controller assembly including a valve housing that presents a valve bore,
said fluid valve including a valve piston slidably mounted in the valve bore.

25. The compressor airflow control assembly as claimed in claim 24,
said controller assembly being devoid of any fluid seal element between the valve housing and valve piston so as to minimize frictional resistance to valve piston sliding movement.

26. The compressor airflow control assembly as claimed in claim 18,
said controller assembly including an actuator housing,
said driven actuator including a reciprocal actuator piston slidably mounted in the housing and drivingly attached to the air valve, with sliding movement of the piston causing shifting of the air valve.

27. The compressor airflow control assembly as claimed in claim 26,
said air valve comprising an inlet guide vane assembly including a plurality of adjustable inlet guide vanes and a vane transmission drivingly interconnecting the vanes,
said piston being drivingly attached to the transmission so that piston movement adjusts the position of the inlet guide vanes.

28. The compressor airflow control assembly as claimed in claim 27; and
a stop located between the housing and the piston, with the stop being operable to limit sliding piston travel and thereby limit adjustment of the inlet guide vanes in at least one adjustment direction.

29. The compressor airflow control assembly as claimed in claim 27,
said piston comprising a double-acting piston, with the housing and piston cooperatively defining opposite chambers that receive pressurized fluid.

30. The compressor airflow control assembly as claimed in claim 26,
said piston comprising a double-acting piston,
said actuator housing and actuator piston cooperatively defining opposite closing and opening chambers that receive pressurized fluid, with fluid flow to the opening chamber causing the actuator to open the air valve and fluid flow to the closing chamber causing the actuator to close the air valve,
said fluid valve being shiftable between a neutral position where the fluid valve restricts fluid flow into and out of the chambers and an opening position where the fluid valve permits pressurized fluid to flow from the source to the opening chamber,
said fluid valve being shiftable between the neutral position and a closing position where the fluid valve permits pressurized fluid to flow from the source to the closing chamber.

31. The compressor airflow control assembly as claimed in claim 30,
said controller including a bypass valve fluidly connectable to a discharge of the compressor and operable to vent airflow from the compressor to ambient when the bypass valve is open,
said controller including a pressure relief valve that fluidly communicates with one of the chambers and the bypass valve,
said pressure relief valve allowing pressurized fluid to flow from the one chamber to the bypass valve and thereby open the bypass valve when the fluid in the one chamber exceeds a predetermined pressure.

32. The compressor airflow control assembly as claimed in claim 18,
said air valve assembly comprising an inlet guide vane assembly including a plurality of adjustable inlet guide vanes and a vane transmission drivingly interconnecting the vanes.
